(19) United States
(12) Patent Application Publication
(10) Pub. No.: US 2019/0043125 A1
(43) Pub. Date: Feb. 7, 2019

(54) CREDIT REPORT DISPUTE AUTOMATION

(71) Applicant: Ronnie D. Cropper, Atlanta, GA (US)

(72) Inventor: Ronnie D. Cropper, Atlanta, GA (US)

(21) Appl. No.: 15/806,215

(22) Filed: Nov. 7, 2017

Related U.S. Application Data
(60) Provisional application No. 62/540,093, filed on Aug. 2, 2017.

(51) Int. Cl. G06Q 40/02; G06Q 30/00; G06F 17/27

(52) U.S. Cl. CPC G06Q 40/025; G06F 17/2795; G06Q 30/01

(57) ABSTRACT

Apparatus and associated methods relate to choosing a credit report dispute communication recipe selected as a function of a borrower's credit report and credit report dispute history, generating a customized credit report dispute communication based on the selected dispute communication recipe adapted as a function of the borrower's credit report and credit report dispute history, and automatically improving the borrower's credit score based on transmitting the customized dispute communication to a credit stakeholder. In an illustrative example, the recipe may be selected as a function of the type of item disputed. The credit report dispute history may include the dispute state based on prior dispute communication. Various examples may advantageously generate dispute communication uniquely customized to each stakeholder based on the borrower's credit report dispute history, for example, by randomizing and synonymizing user-provided dispute item characteristics inserted within a dispute communication template selected as a function of the selected recipe.

### CROSS-REFERENCE TO RELATED APPLICATIONS

This application claims the benefit of U.S. Provisional Application No. 62/540,093, filed on Aug. 2, 2017 and entitled “Credit Report Dispute Automation”, the entire disclosure of which is hereby incorporated herein by reference.

### TECHNICAL FIELD

Various embodiments generally relate to creating credit report dispute communication.

### BACKGROUND

Credit is an indication of trust. Credit may be provided based on a degree of trust. Trust between a buyer and seller may allow some transactions to proceed without immediate payment. For example, in some transactions, a selling entity may extend financial credit to a buying entity. Financial credit may allow delivery of a good or service based on a seller's degree of trust that the buyer will provide payment later. The seller's degree of trust that the buyer will provide payment may be referred to as the buyer's credit risk for late payment, or non-payment. For example, a buyer that may be unlikely to timely pay, may be evaluated by some sellers as a high credit risk. In an illustrative example, a buyer very likely to pay on time may be considered a low credit risk by some sellers.

Some entities extending credit may be creditors, sellers, or lenders. Entities receiving credit may be known in some scenarios as borrowers, buyers, or debtors. In an illustrative example, a borrower may be considered to owe a creditor an amount of money based on the value goods or services received in a credit transaction. An amount of money owed to a creditor may be known as a debt. Paying a creditor an amount owed from a credit transaction may be referred to as paying the debt. Payment of debt owed to some creditors may require an amount of money in excess of the value of goods and services received in a credit transaction. Some creditors add to the amount due based on the time elapsed since the credit transaction. An amount charged by a creditor based on the time elapsed since the credit transaction may be known as interest. Some interest may be calculated as a percentage of the transaction value of a good or service. A percentage of the transaction value of a good or service may be known as an interest rate.

Some creditors may adjust the interest rate charged to a borrower based on the borrower's credit risk. A borrower's credit risk may be determined by some creditors based on the borrower's credit history as recorded in a credit report. Providers of borrower credit reports may be known as credit bureaus or credit reporting agencies. Entities extending credit, entities receiving credit, and providers of borrower credit reports may be known as credit stakeholders. Some creditors may obtain a borrower's credit report including records of prior credit transactions by the borrower, amounts borrowed, and debt payment history. Some credit reports include a numerical value assessing the prospective borrower's credit risk based on debt payment history. Such a credit score may be used by a creditor to determine if credit should be extended to a prospective borrower.

A borrower with a poor credit score may have difficulty obtaining credit. For example, some lenders may deny credit to borrowers with credit scores below a threshold determined by the lender. In some examples, a borrower with a poor credit score may be able to obtain credit only at interest rates unfavorable to the borrower. In an illustrative example, a borrower with a good credit score may be offered credit terms advantageous to the borrower. Some borrowers may advantageously obtain lower interest rates by improving their credit score.

If a borrower's poor credit score is a result of incorrect negative credit report information, the borrower may be able to improve the credit score by correcting disputed items in the credit report. Disputing incorrect credit report items may be a lengthy and tedious process in some scenarios. Various types of documentation may be required to dispute some types of incorrect negative information in a credit report. For example, bank records including cleared payments, and letters from lenders certifying loan payoffs may be required to clear certain types of incorrect information in a borrower's credit report. To repair their credit, a borrower may be required to individually compose a letter to each credit report agency to dispute incorrect information.

### SUMMARY

Apparatus and associated methods relate to choosing a credit report dispute communication recipe selected as a function of a borrower's credit report and credit report dispute history, generating a customized credit report dispute communication based on the selected dispute communication recipe adapted as a function of the borrower's credit report and credit report dispute history, and automatically improving the borrower's credit score based on transmitting the customized dispute communication to a credit stakeholder. In an illustrative example, the recipe may be selected as a function of the type of item disputed. The credit report dispute history may include the dispute state based on prior dispute communication. Various examples may advantageously generate dispute communication uniquely customized to each stakeholder based on the borrower's credit report dispute history, for example, by randomizing and synonymizing user-provided dispute item characteristics inserted within a dispute communication template selected as a function of the selected recipe.

Various embodiments may achieve one or more advantages. For example, some embodiments may improve a user's access to credit. This facilitation may be a result of automatically generating credit report dispute communication customized to improve the user's credit score. In some embodiments, customized credit report dispute communication may be automatically generated to dispute items in the user's credit report. Such automatic credit report dispute communication generation may reduce a user's cost to obtain credit. Such reduced credit cost may be a result of lower interest rates and other advantageous credit terms offered to borrowers with an improved credit score. Some embodiments may reduce a user's effort creating communication to dispute incorrect negative items in their credit report. This facilitation may be a result of selecting a dispute communication recipe based on the user's credit report and dispute history, and customizing the recipe based on capturing the user's responses to questions determined as a function of the credit report. Such automated recipe selection and user response capture may reduce the likelihood of the user omitting crucial dispute information or using an ineffective dispute communication format. In some embodiments, the effectiveness of dispute communication may be increased. This facilitation may be a result of adapting the selected dispute communication recipe as a function of the dispute state based on prior dispute communication. For example, dispute communication may be uniquely customized to each stakeholder based on the dispute iteration with that stakeholder.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an operational view of an embodiment credit report dispute resolution system choosing a credit report dispute communication recipe selected as a function of a borrower's credit report and credit report dispute history, generating a customized credit report dispute communication based on the selected dispute communication recipe adapted as a function of the borrower's credit report and credit report dispute history, and automatically improving the borrower's credit score based on transmitting the customized dispute communication to a credit stakeholder.

FIG. 2A and FIG. 2B depicts an exemplary process flow of an embodiment Dispute Resolution Engine (DRE).

FIG. 3A and FIG. 3B depicts an exemplary process flow of an alternate embodiment Dispute Resolution Engine (DRE).

FIG. 4 depicts an exemplary tabular view of an embodiment synonym engine.

FIG. 5A through FIG. 5C depicts an exemplary tabular view of an embodiment credit report data item model.

FIG. 6A and FIG. 6B depicts an exemplary tabular view of an embodiment data element model.

FIG. 7A and FIG. 7B depicts exemplary credit impact summaries.

FIG. 8 depicts exemplary dispute instructions.

FIG. 9A through FIG. 9RR depicts an exemplary tabular view of an embodiment dispute resolution model.

FIG. 10A through FIG. 10I depict exemplary screen shots of an illustrative mobile device user interface view of an embodiment mobile application.

Like reference symbols in the various drawings indicate like elements.

### DETAILED DESCRIPTION OF ILLUSTRATIVE EMBODIMENTS

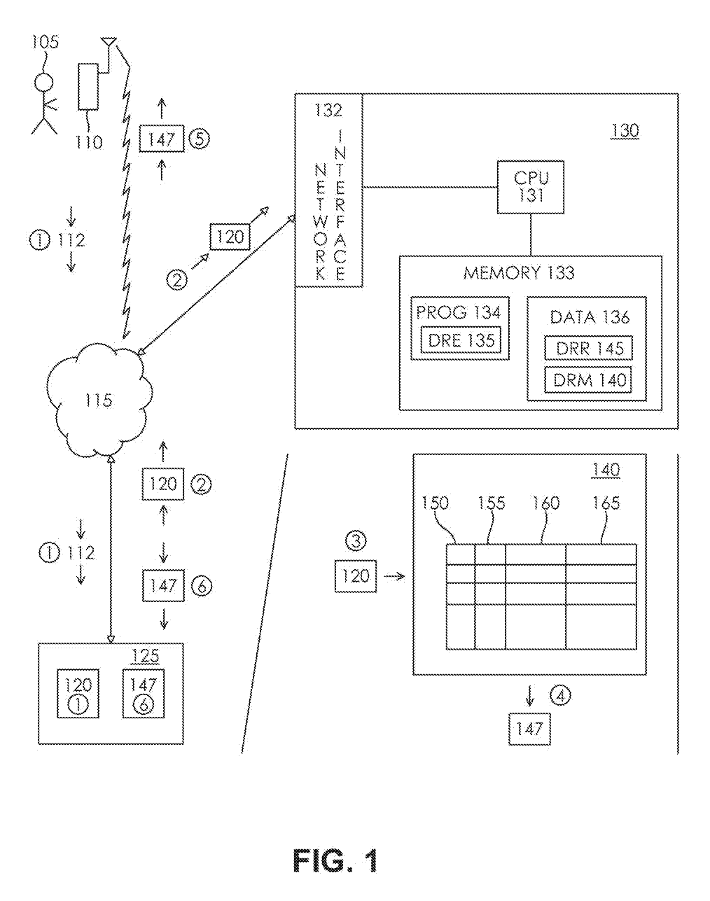

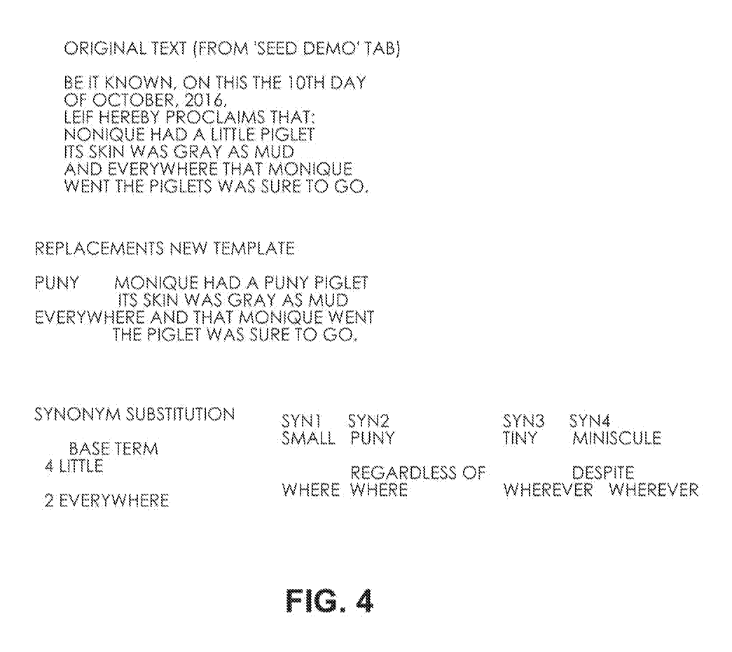

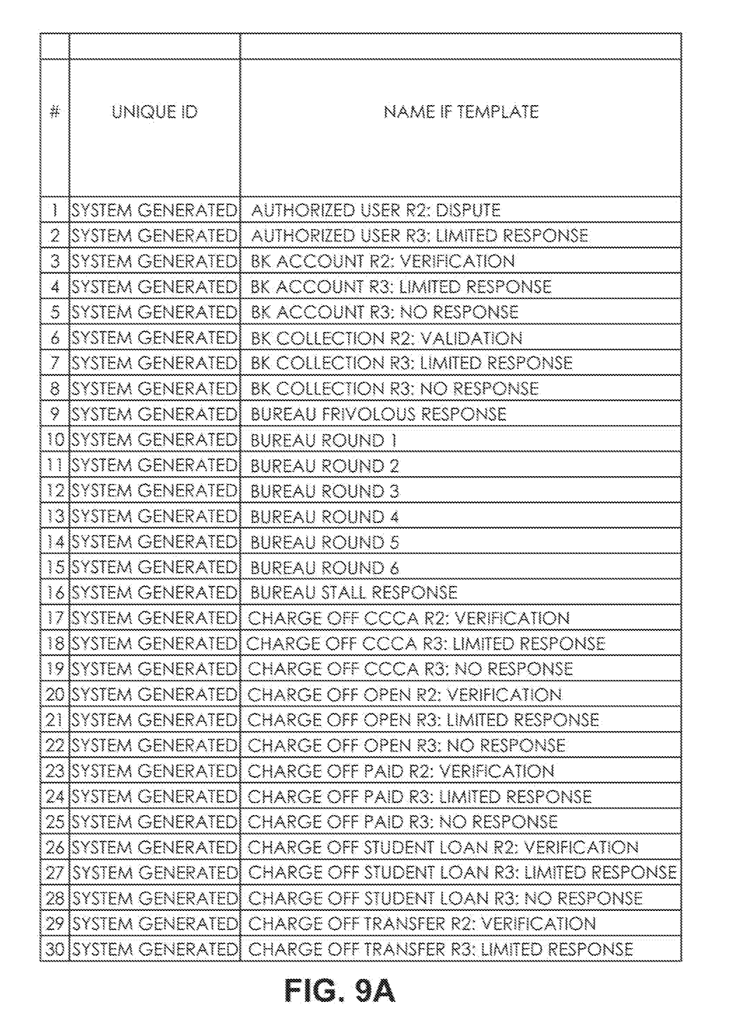

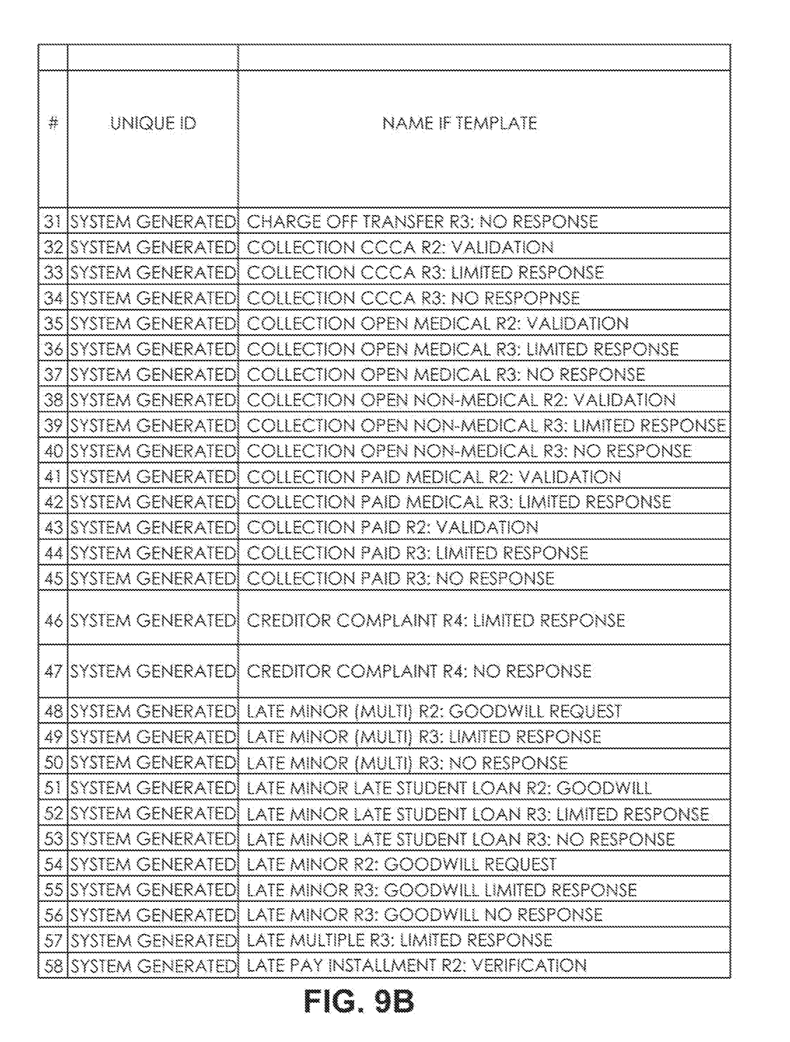

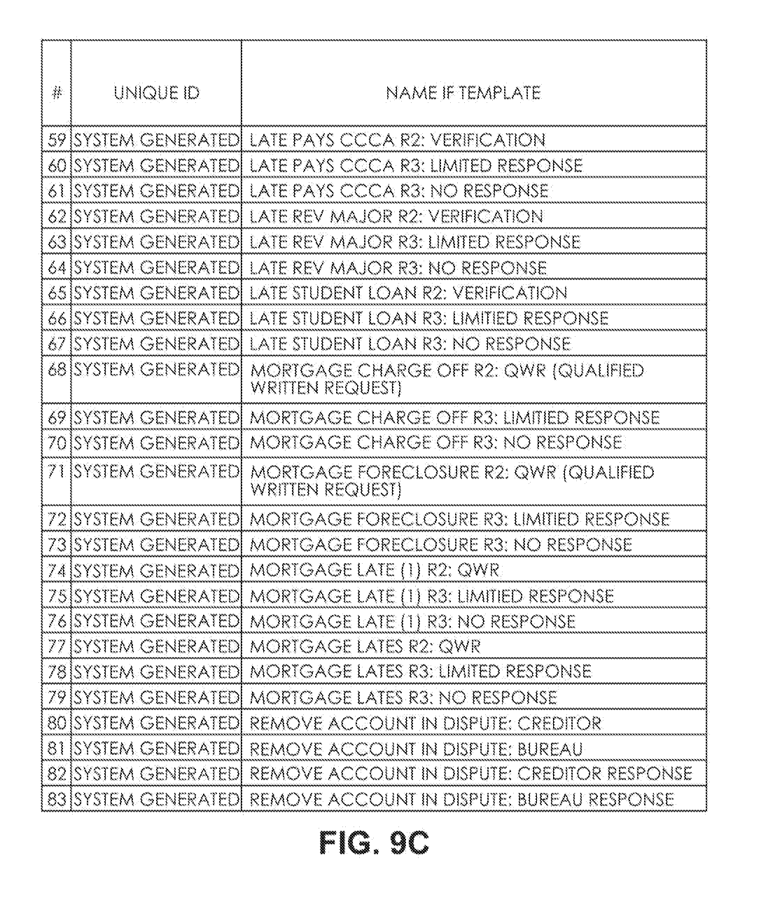

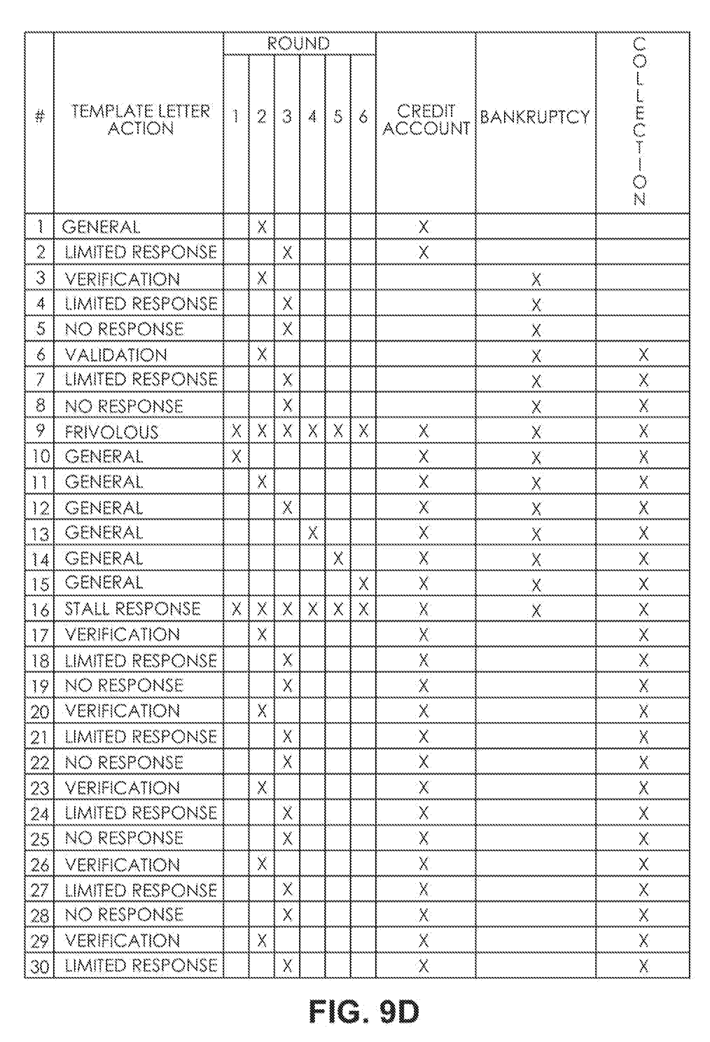

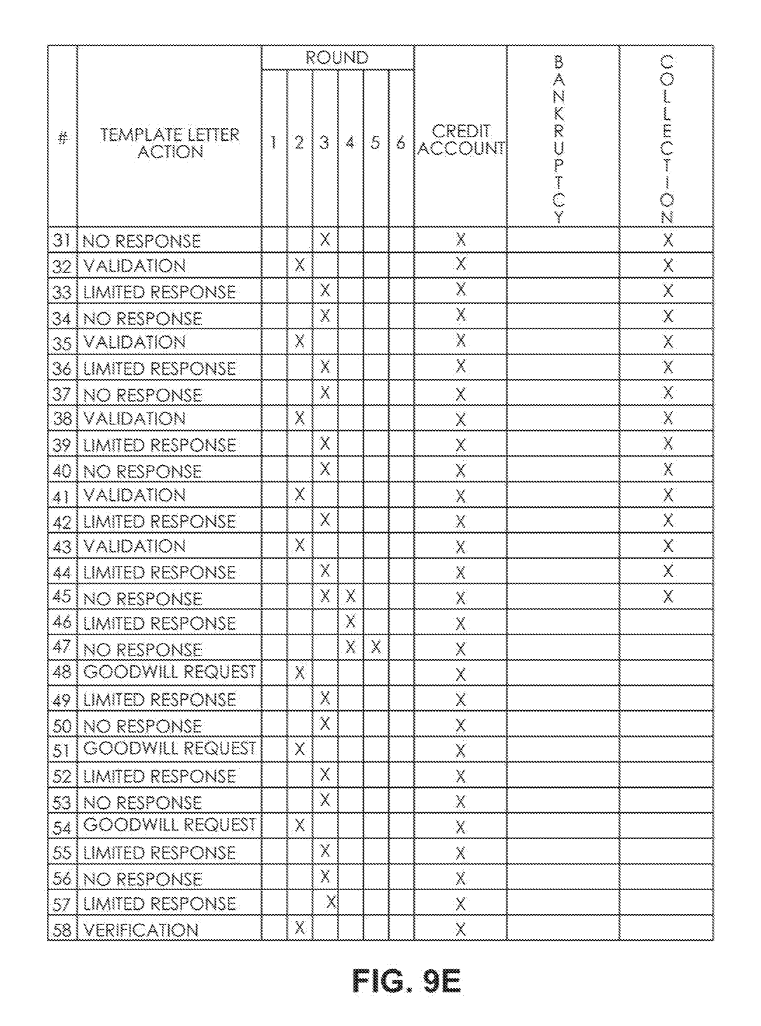

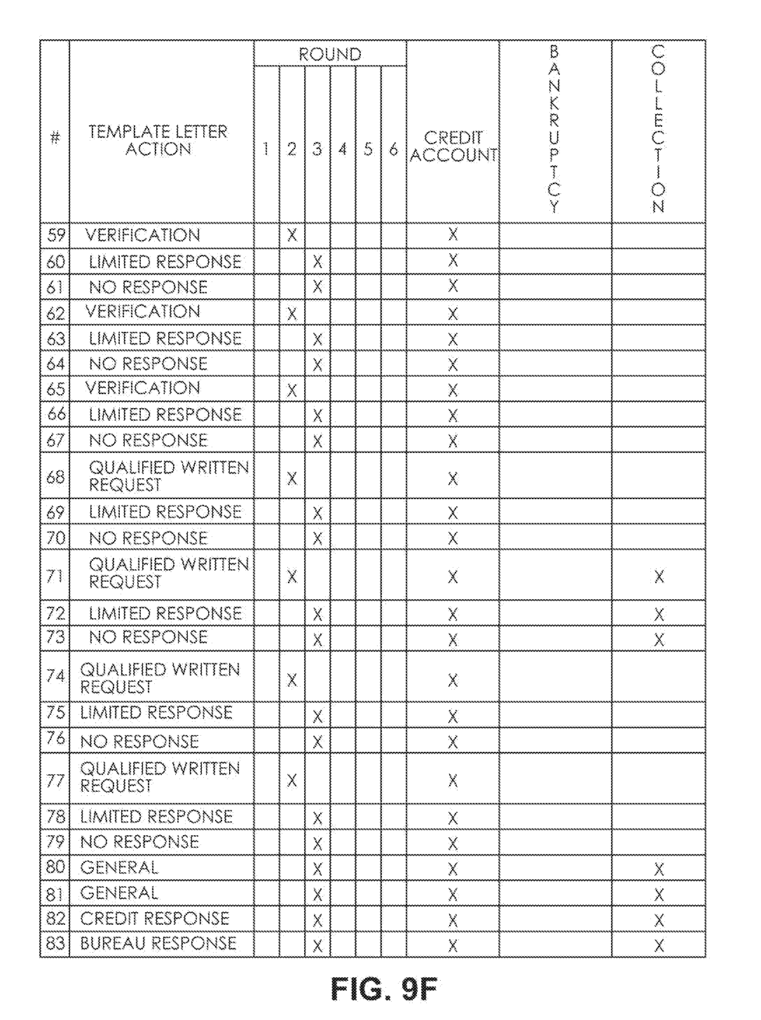

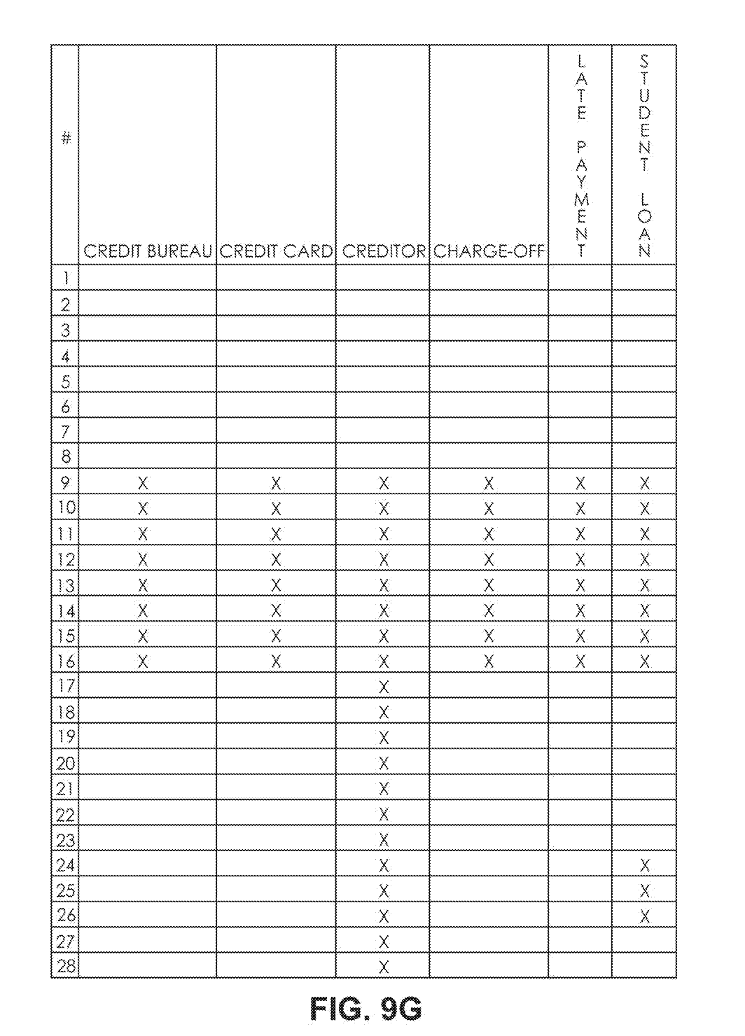

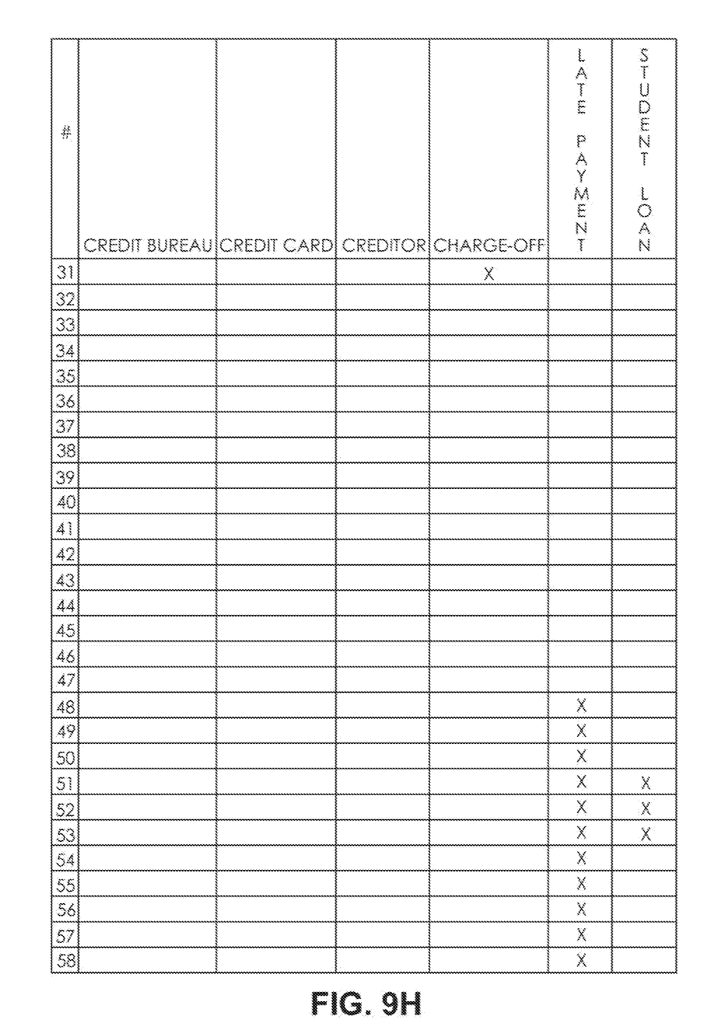

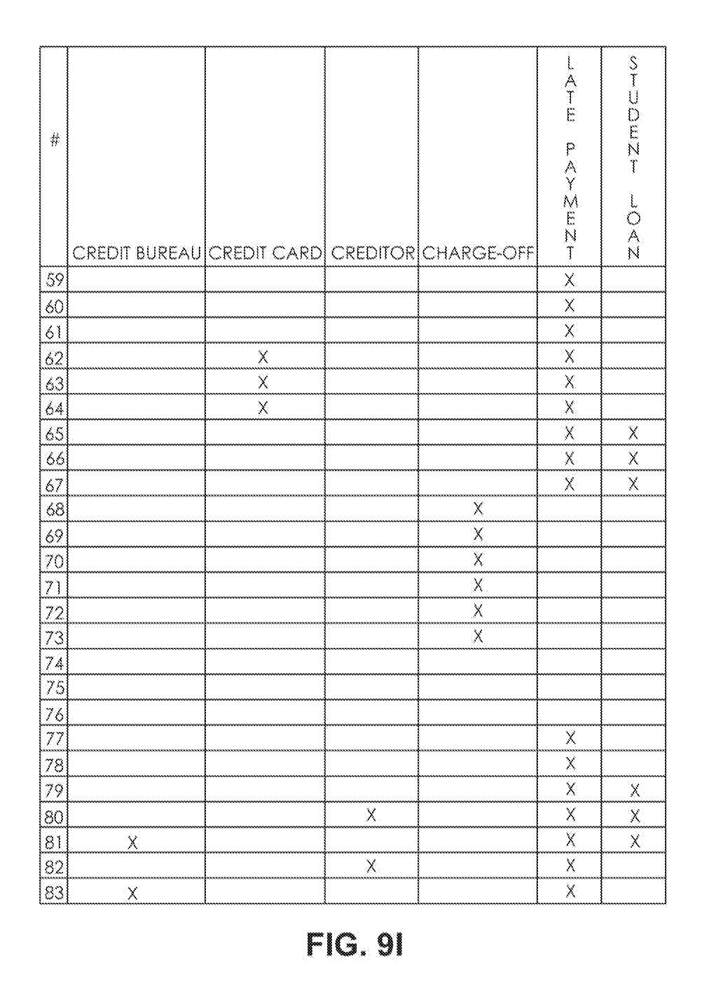

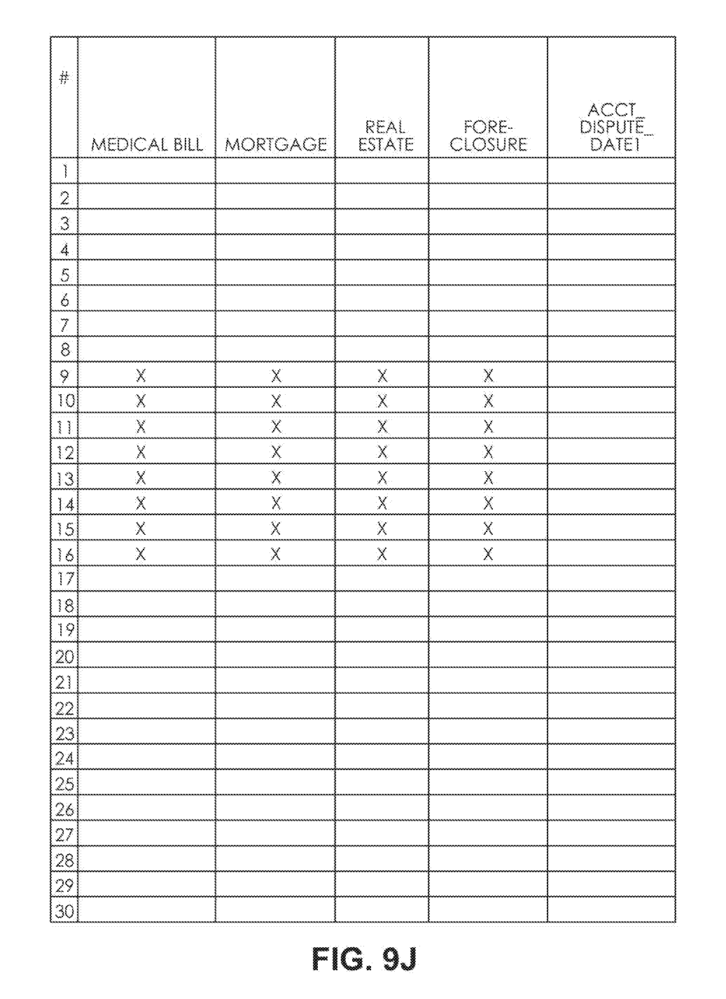

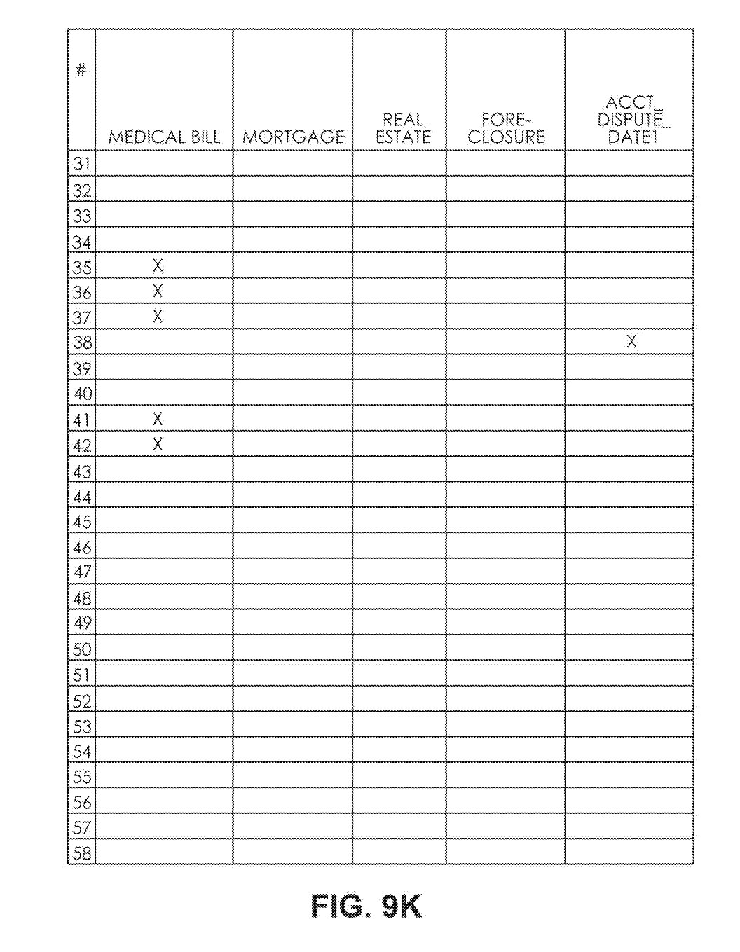

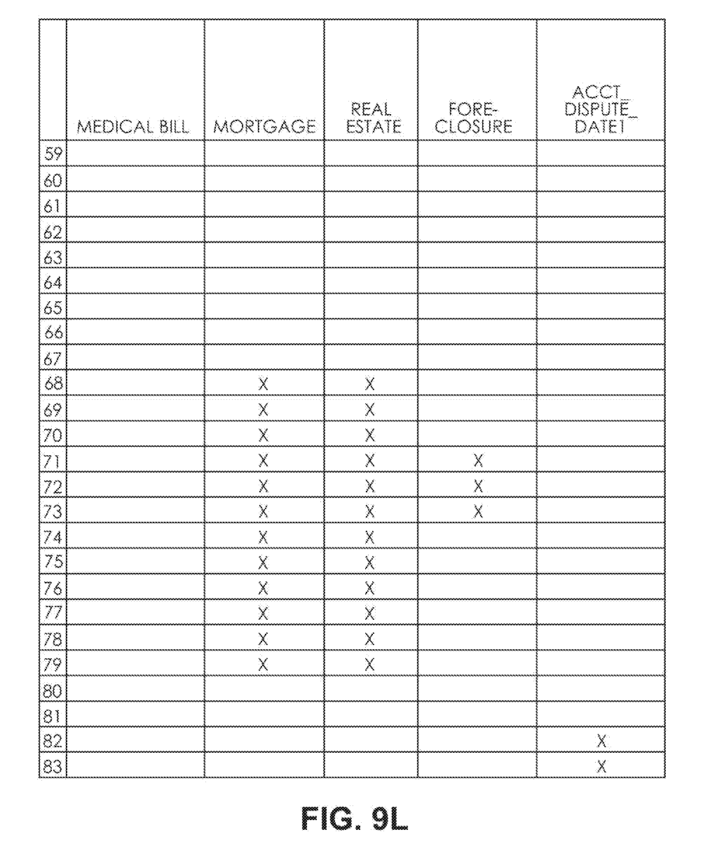

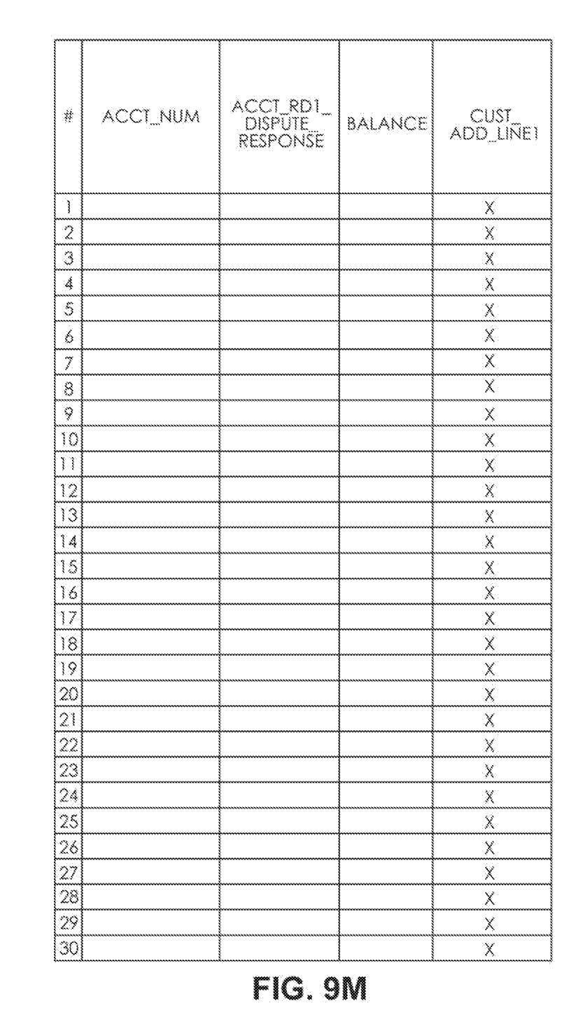

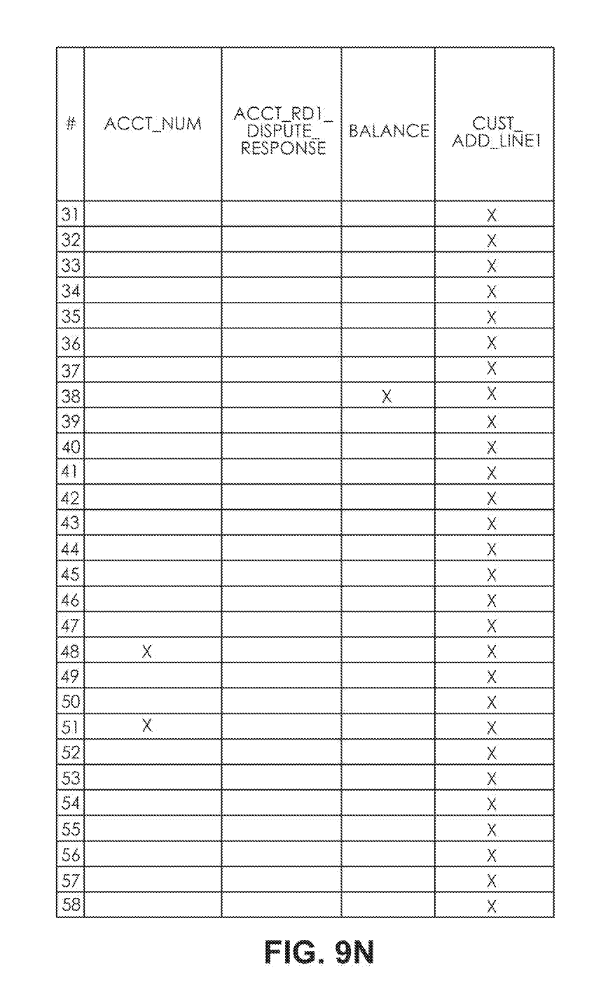

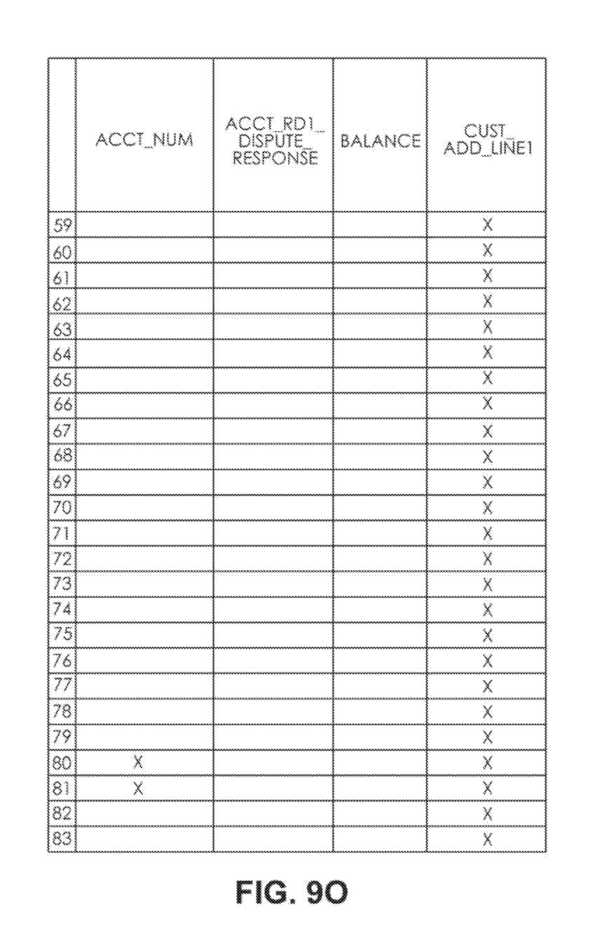

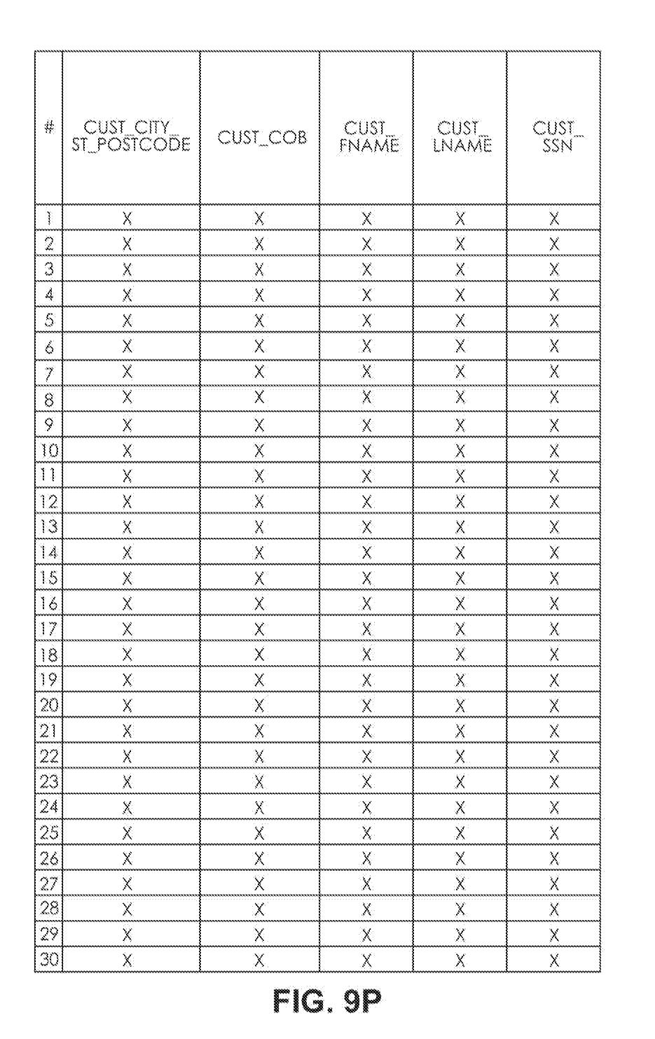

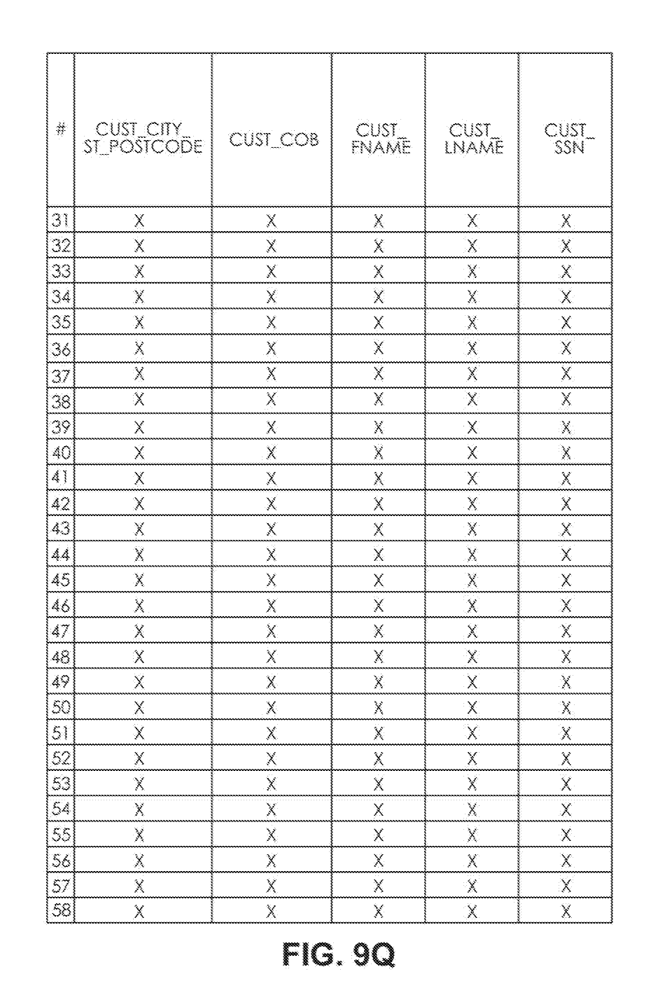

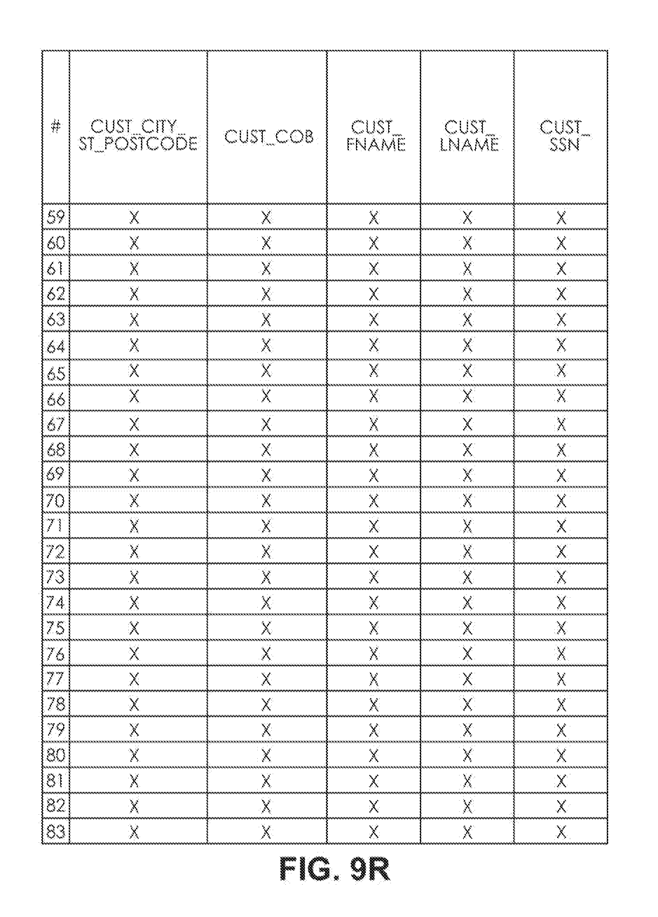

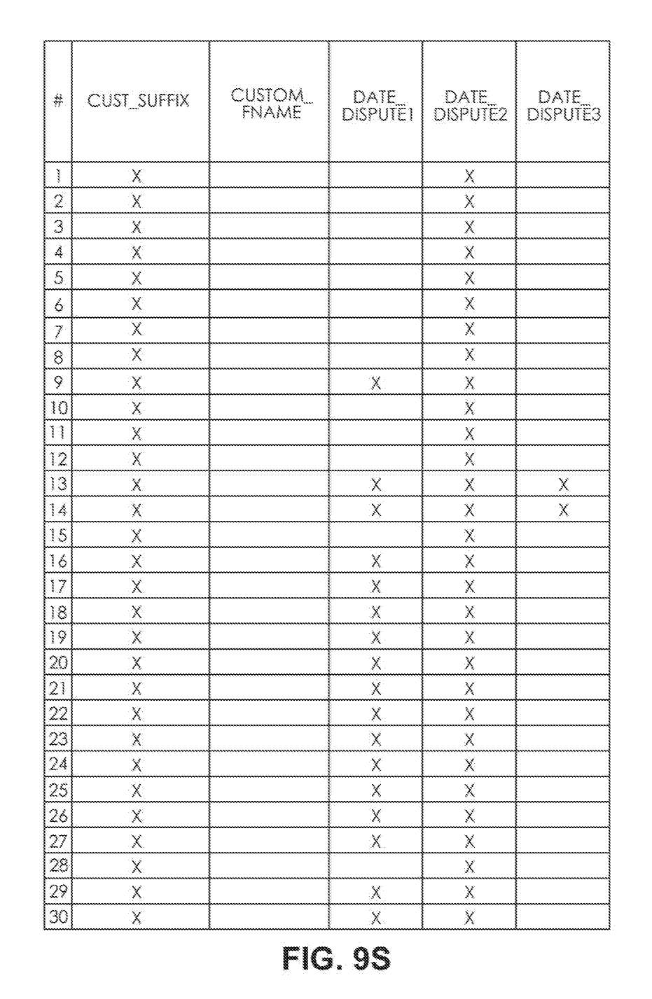

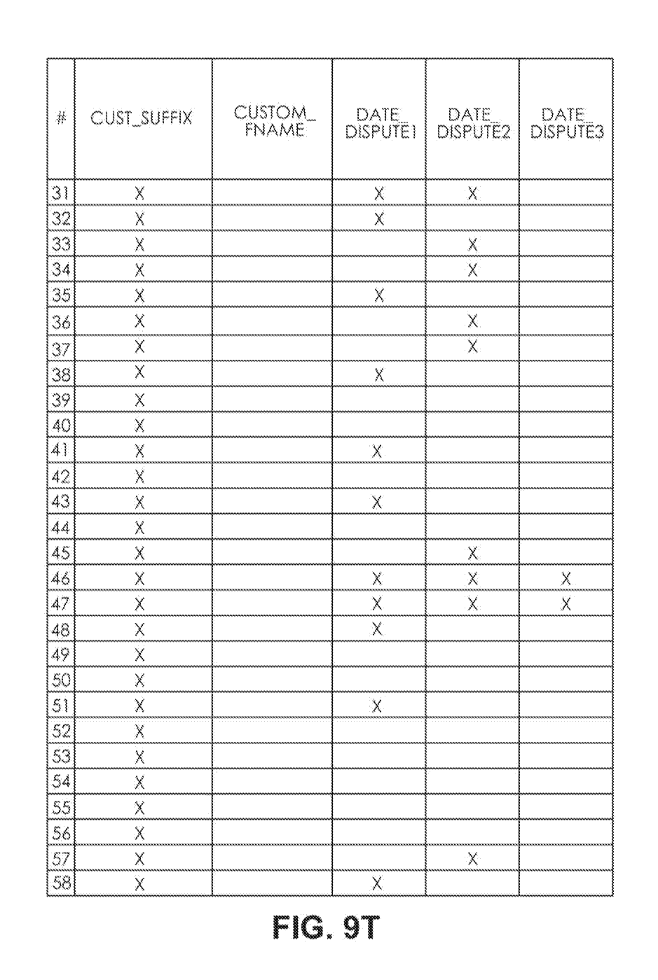

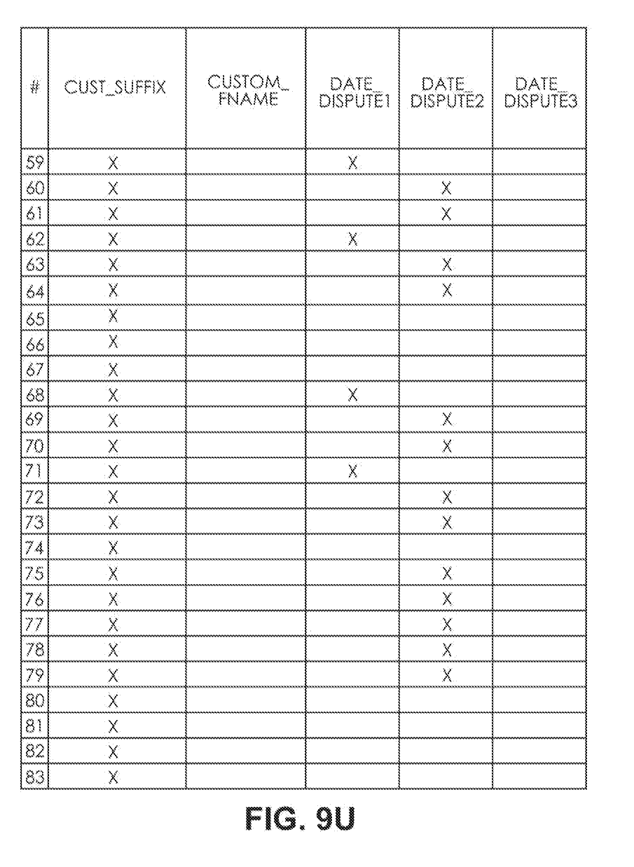

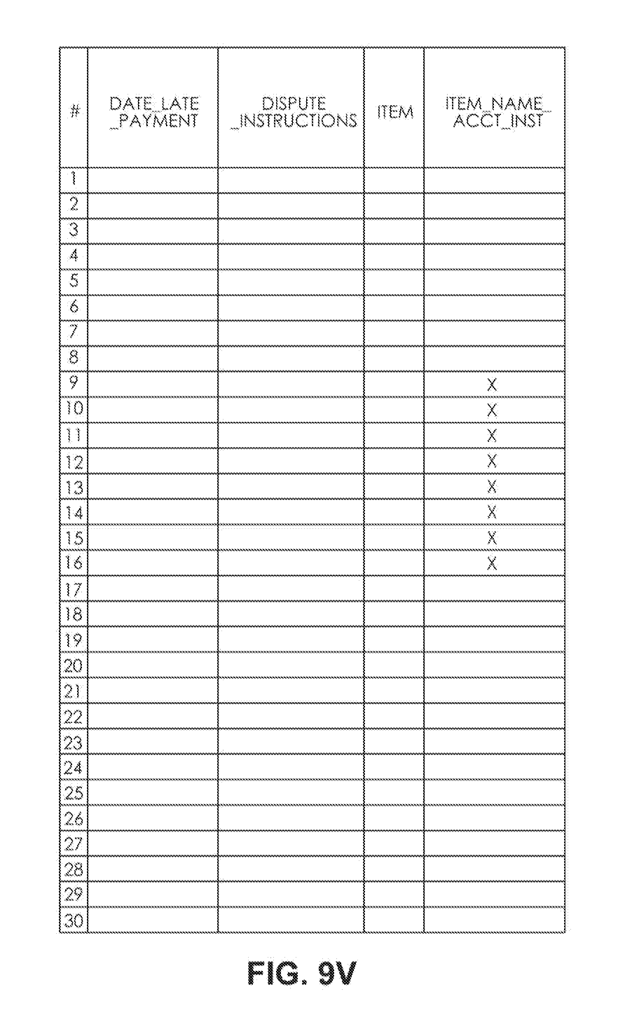

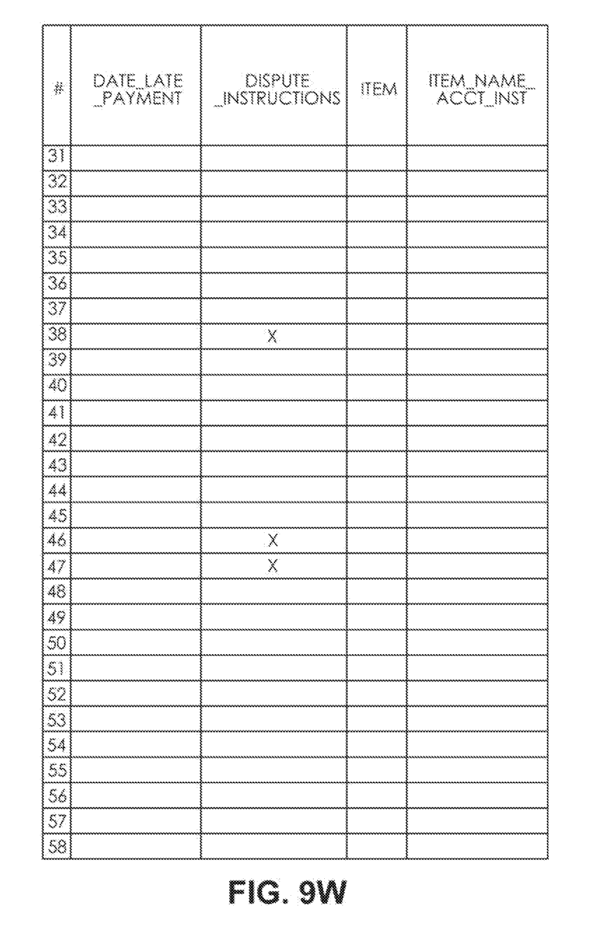

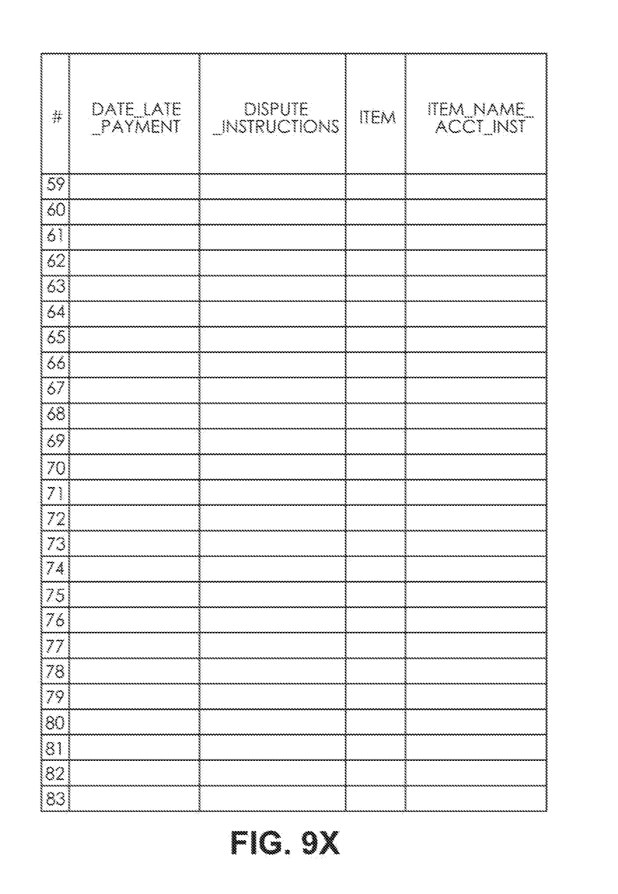

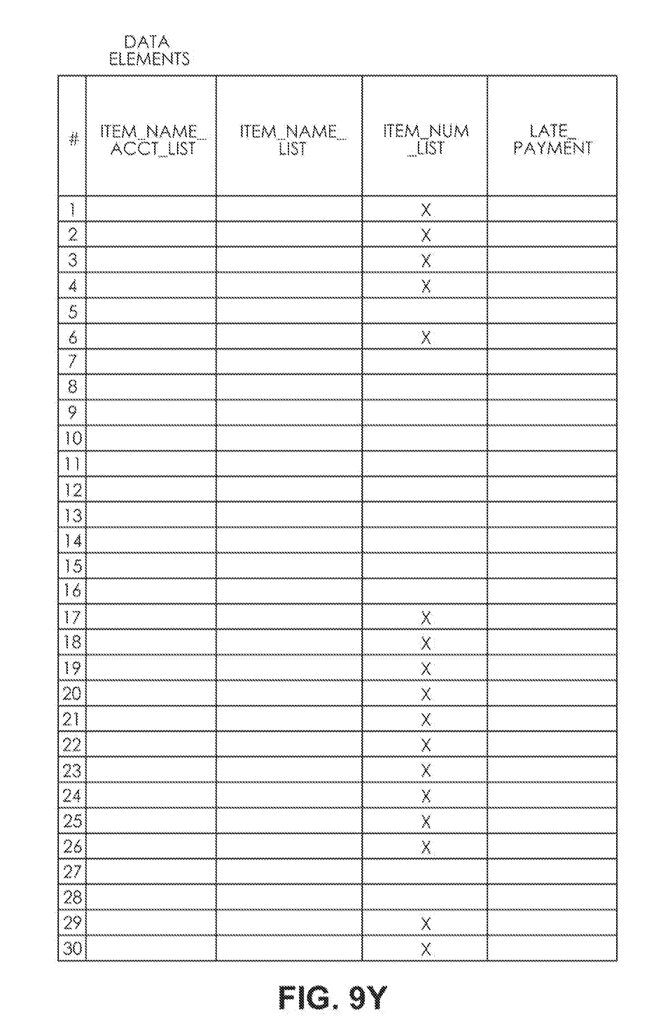

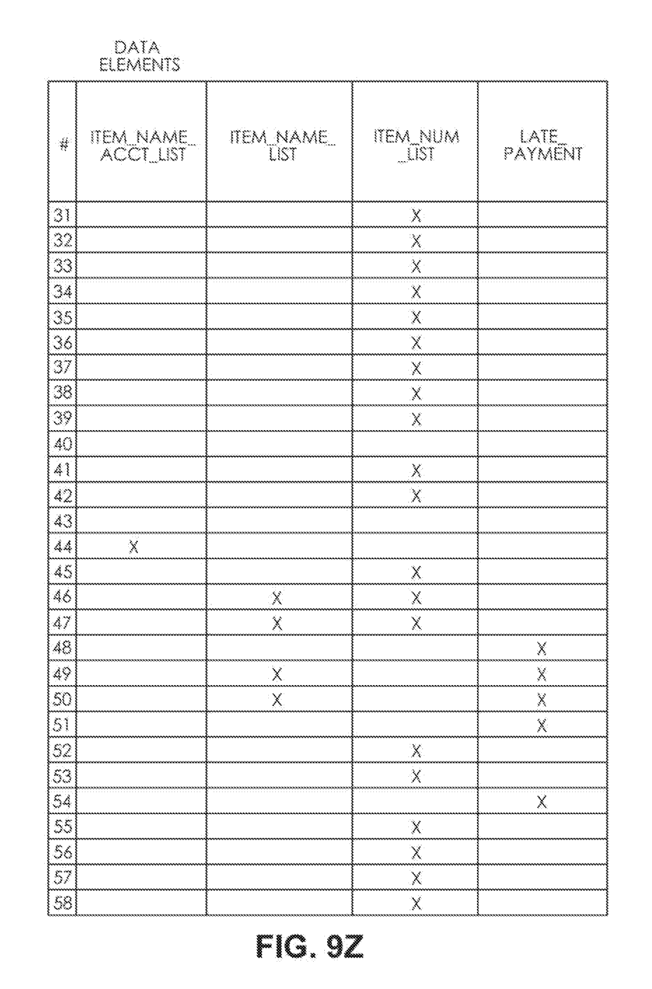

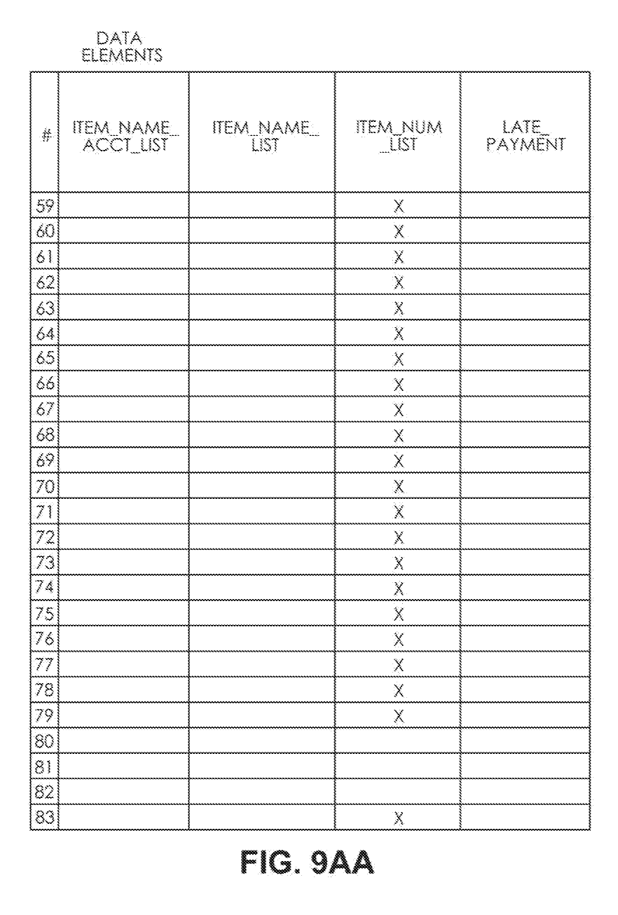

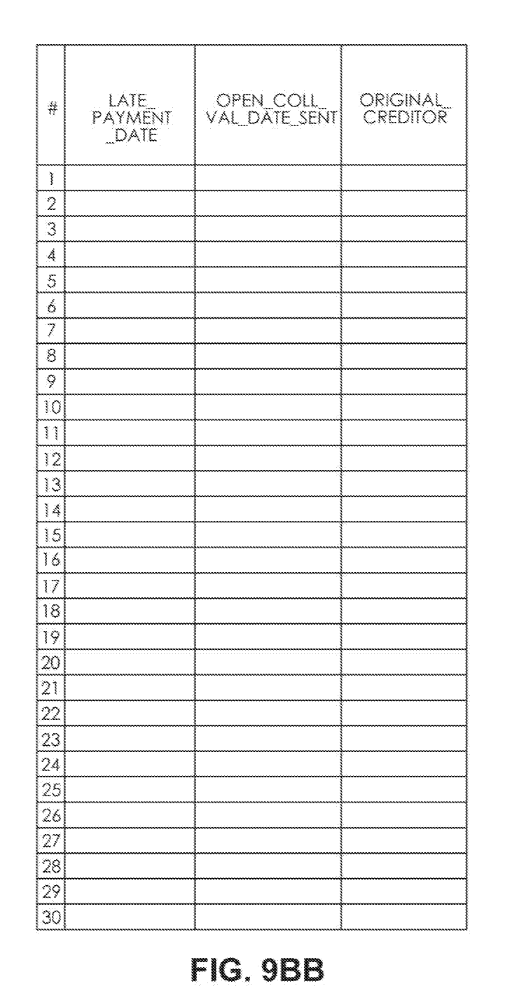

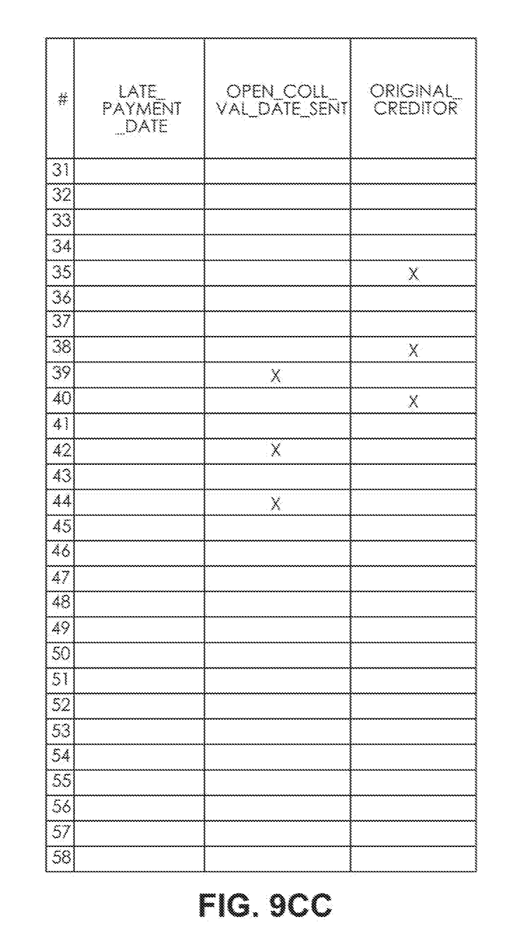

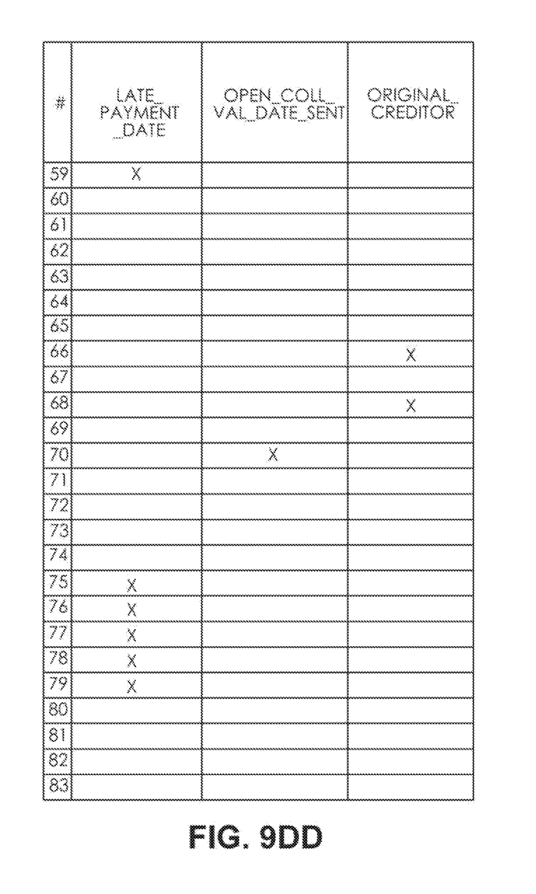

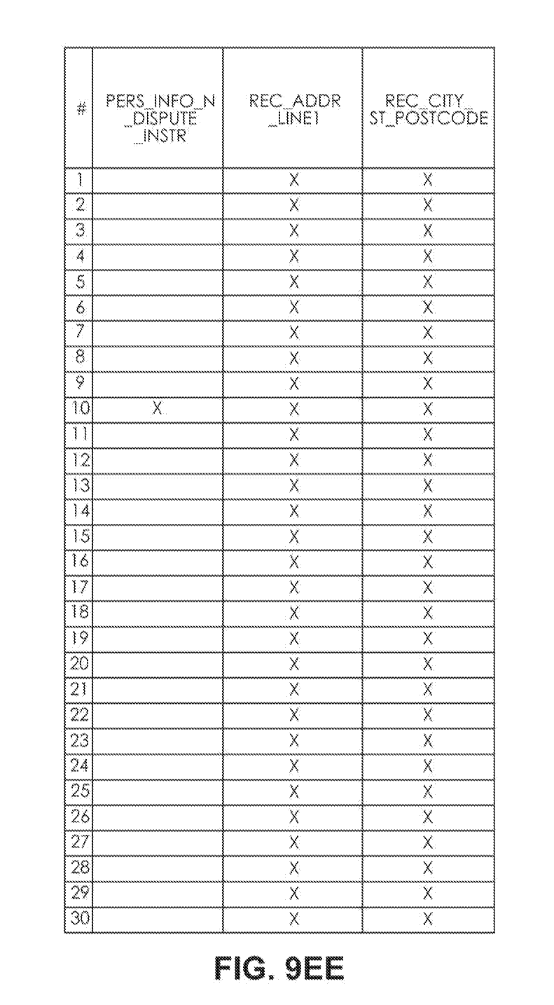

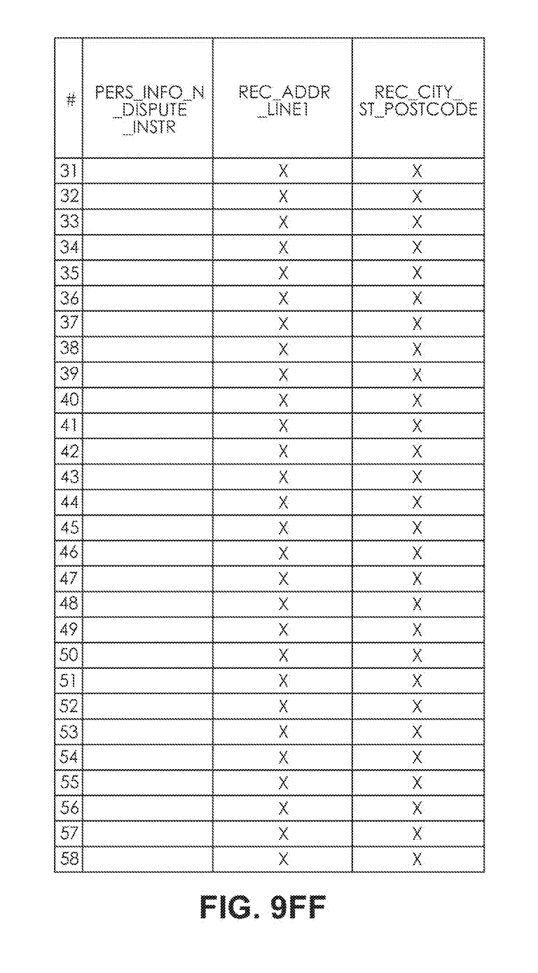

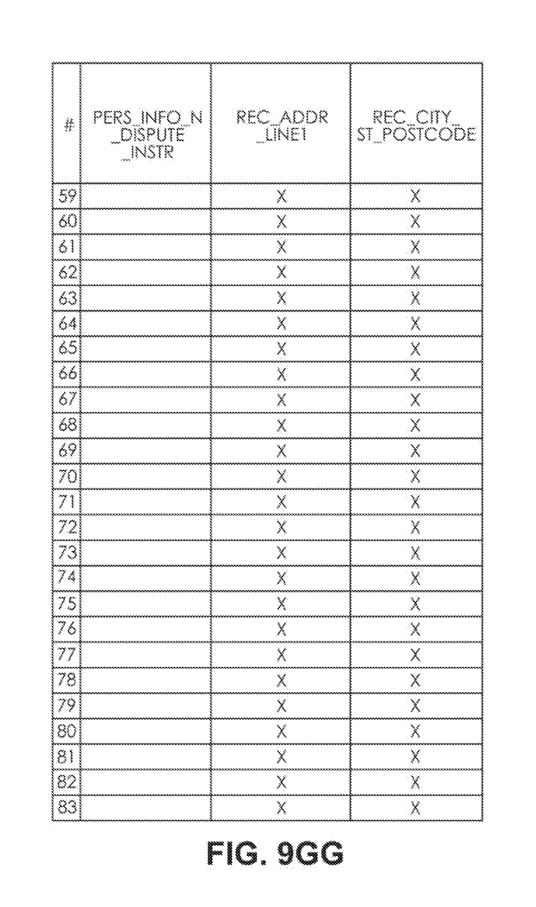

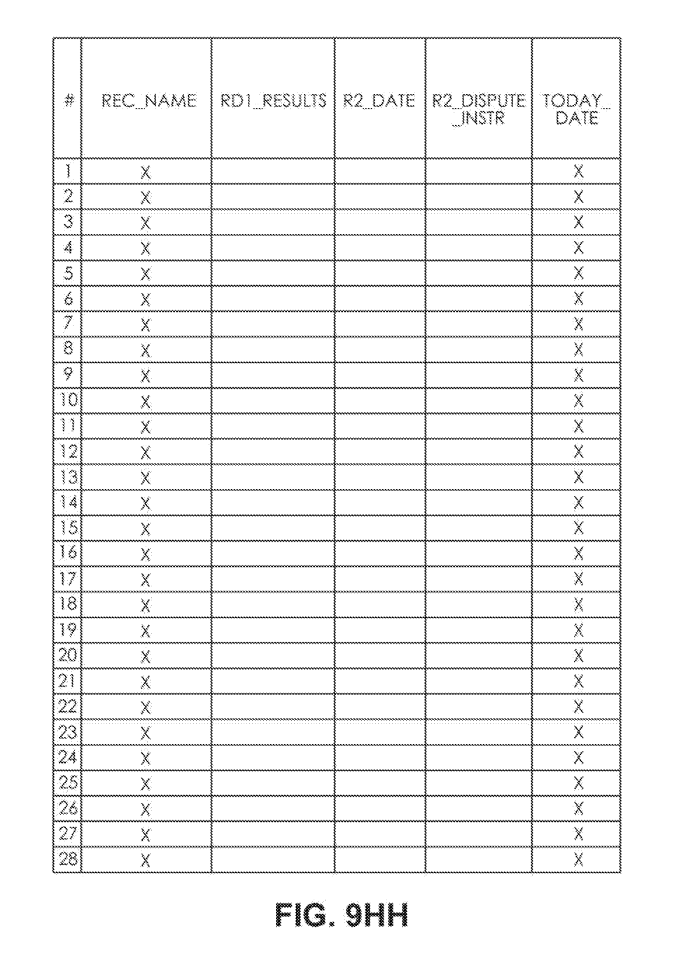

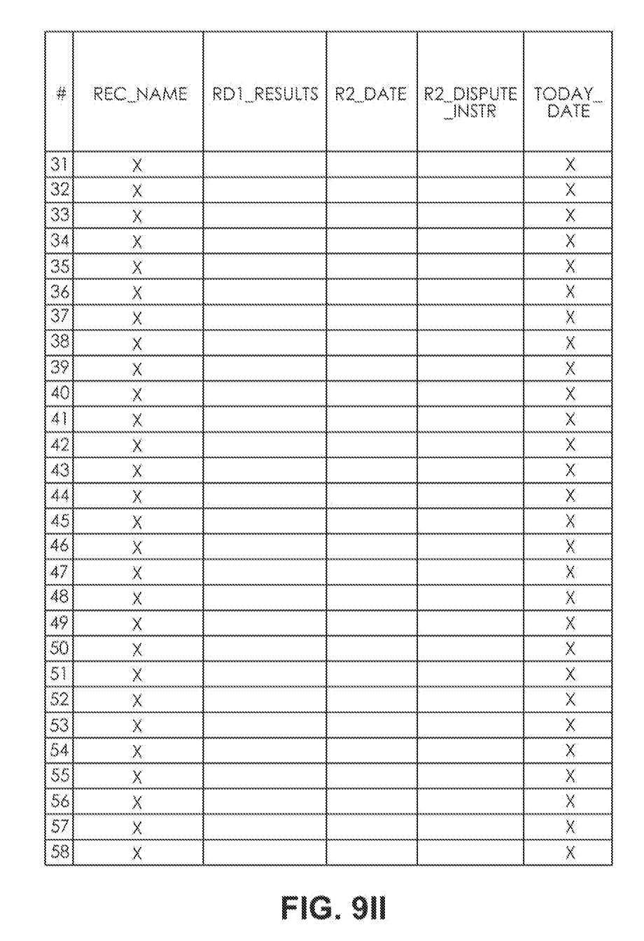

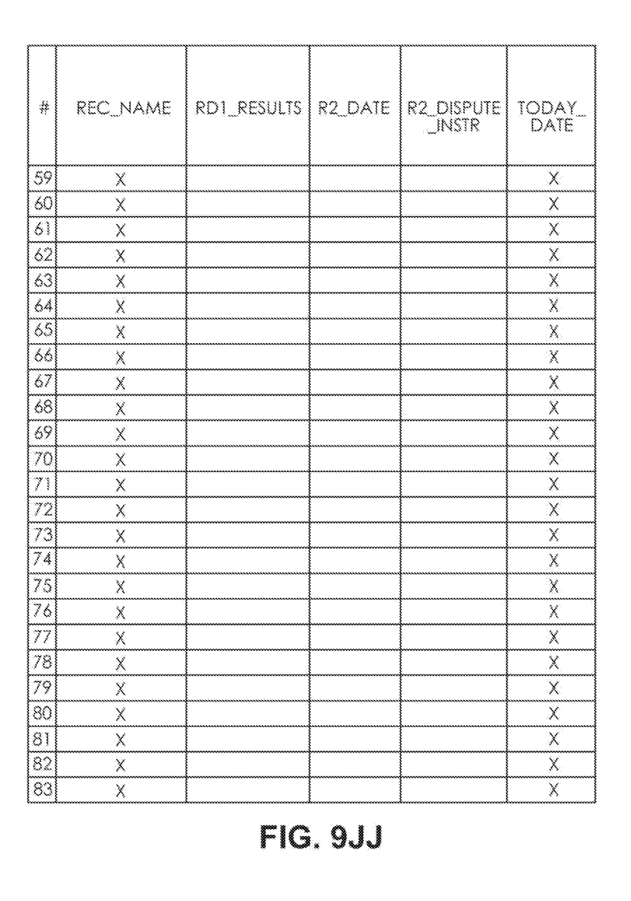

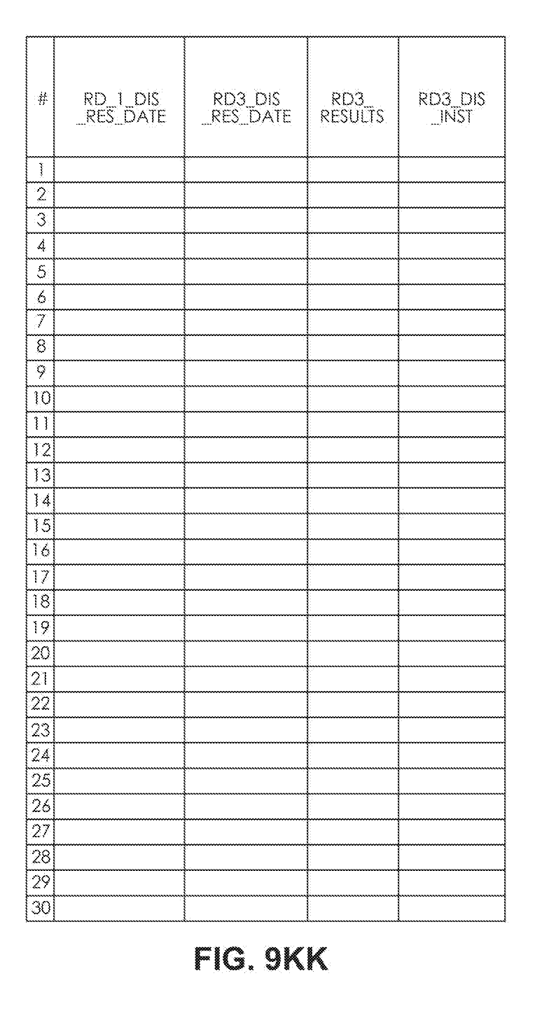

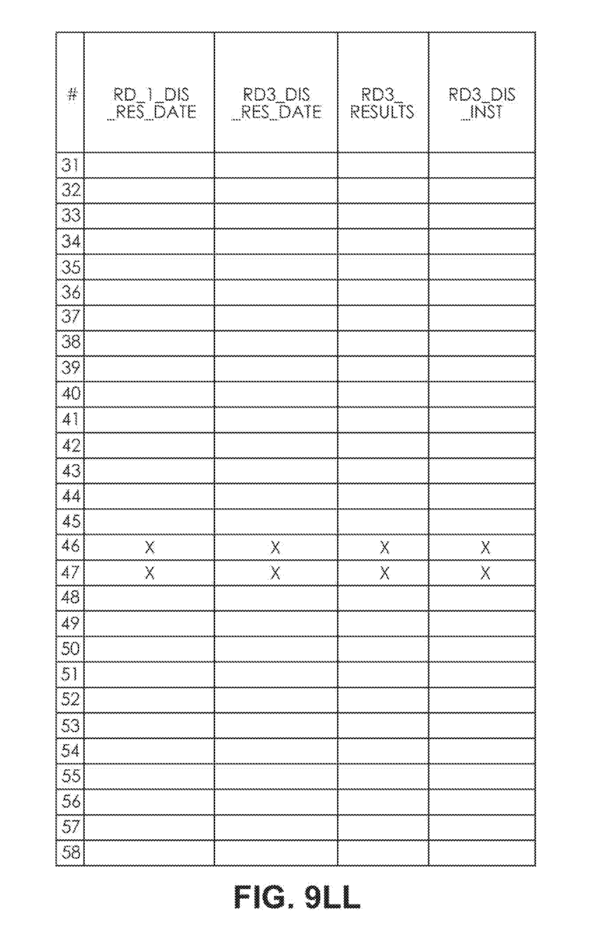

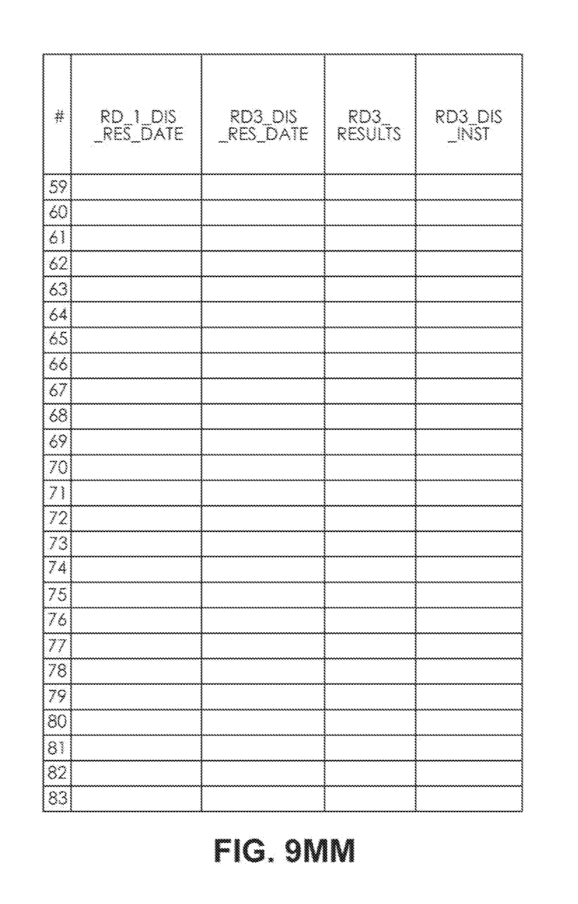

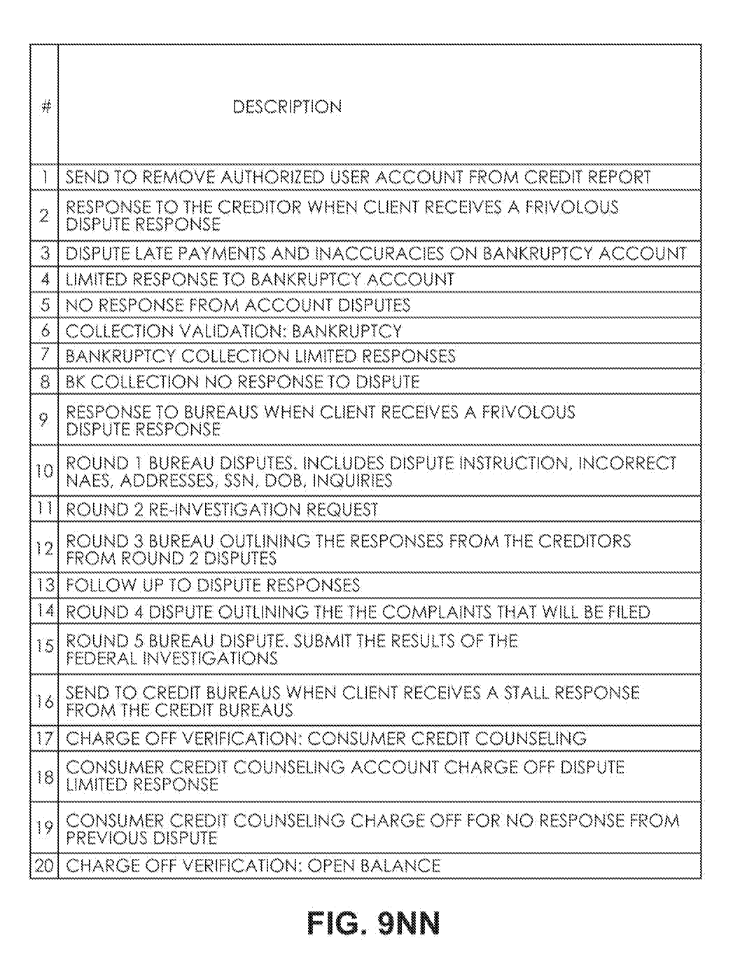

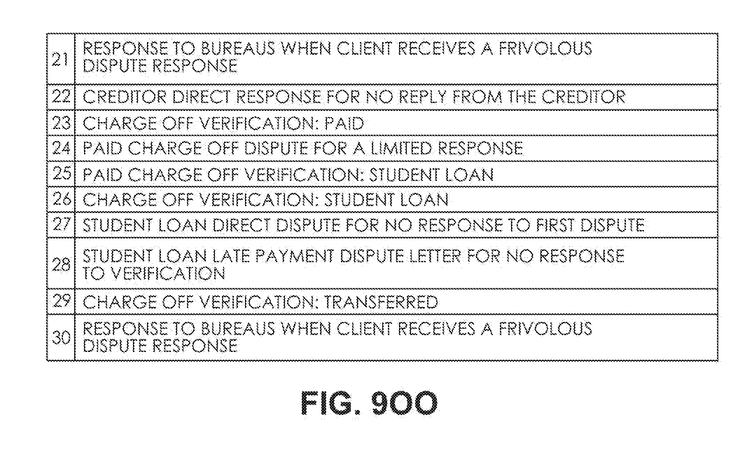

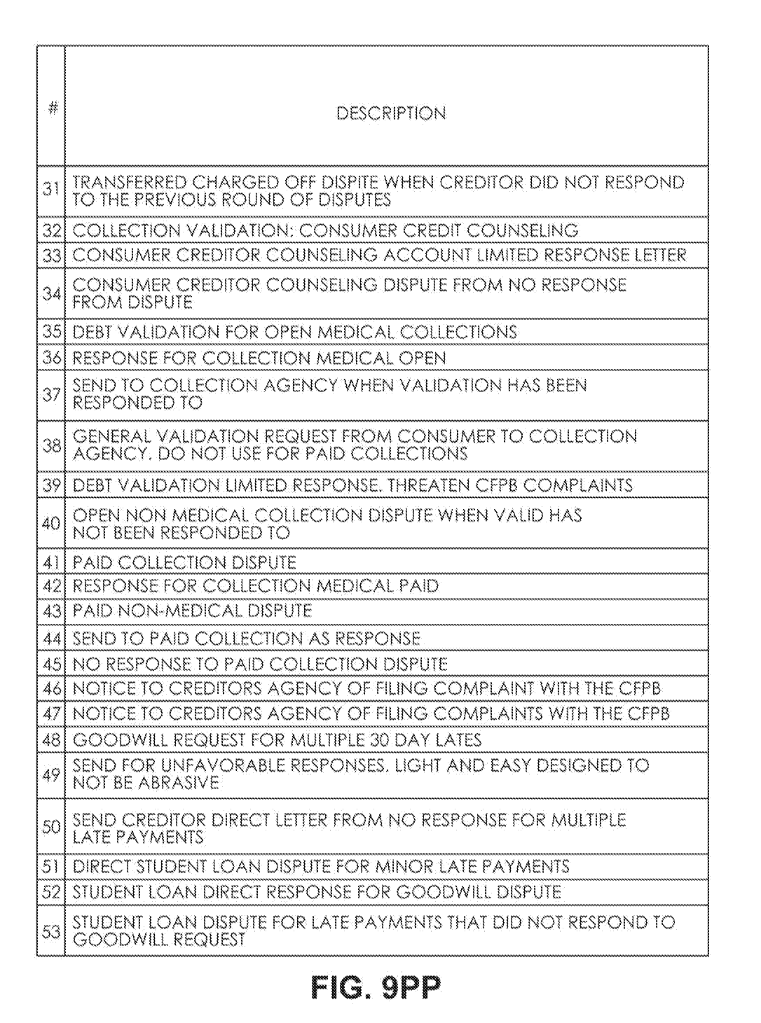

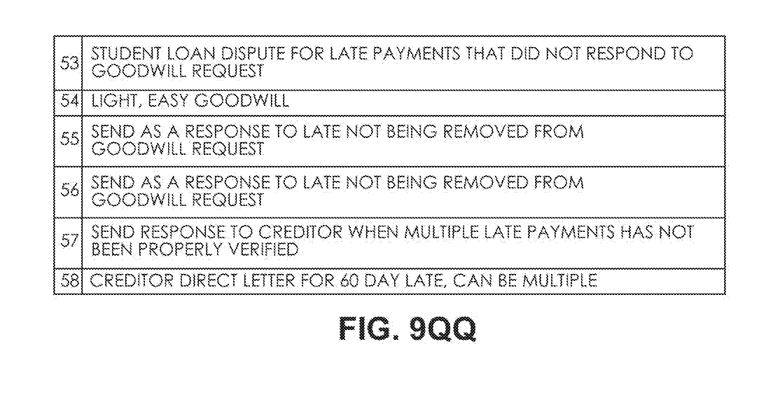

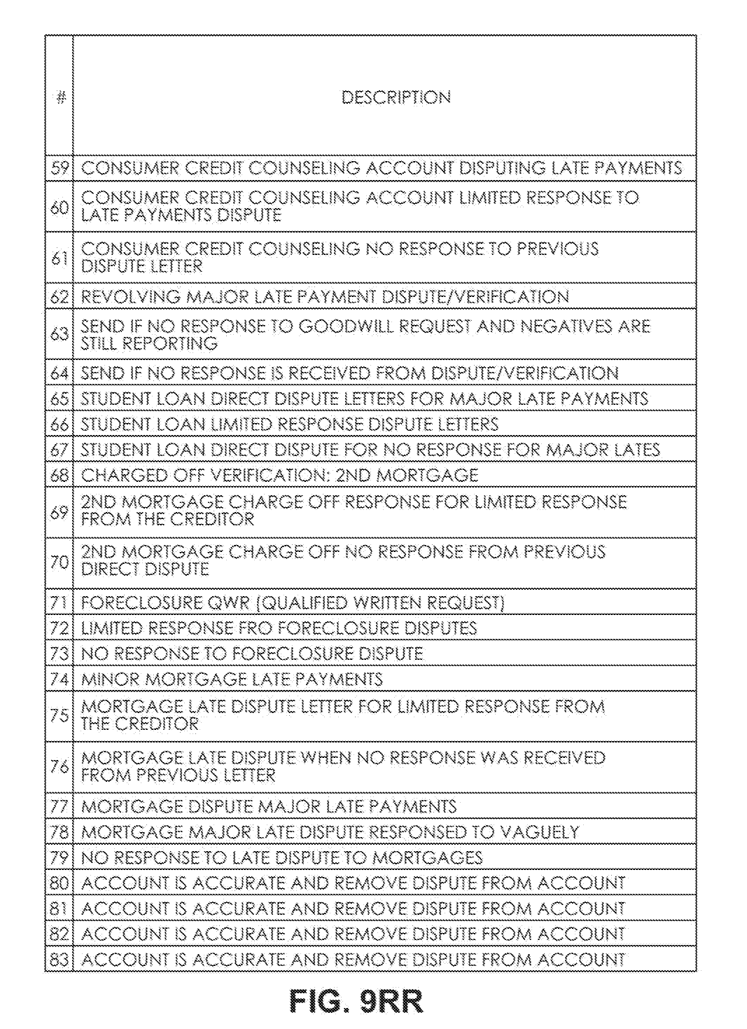

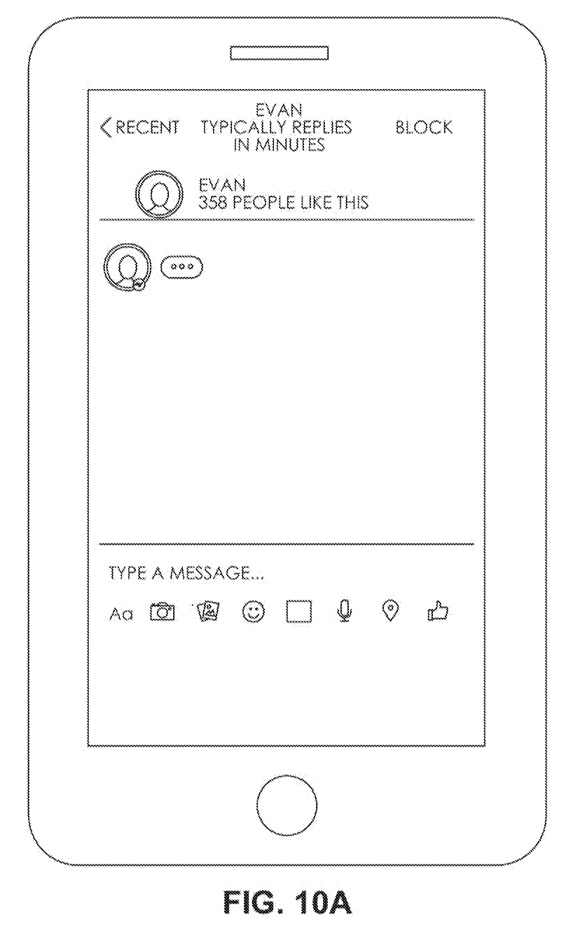

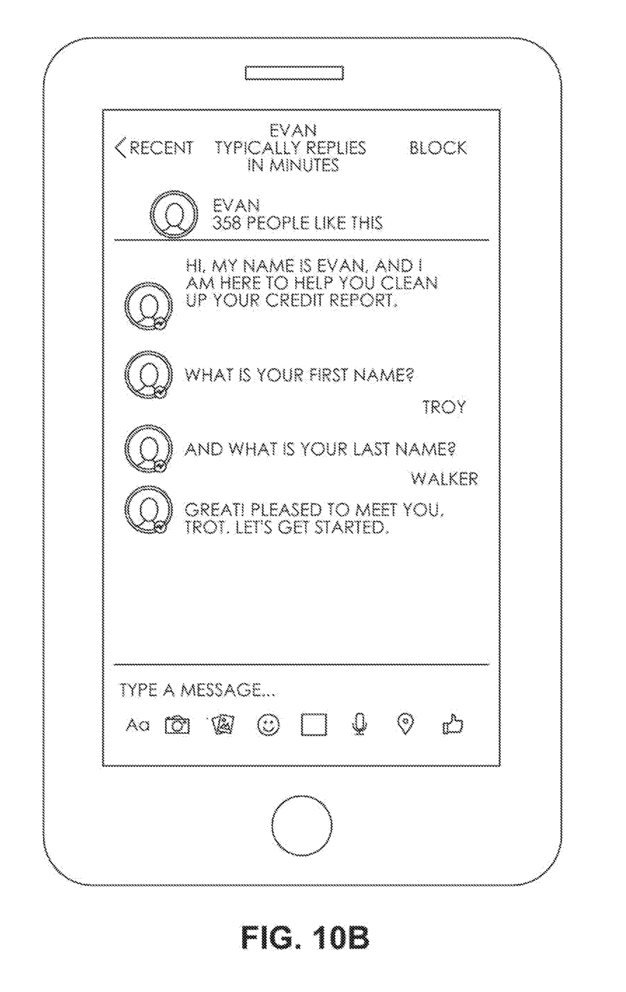

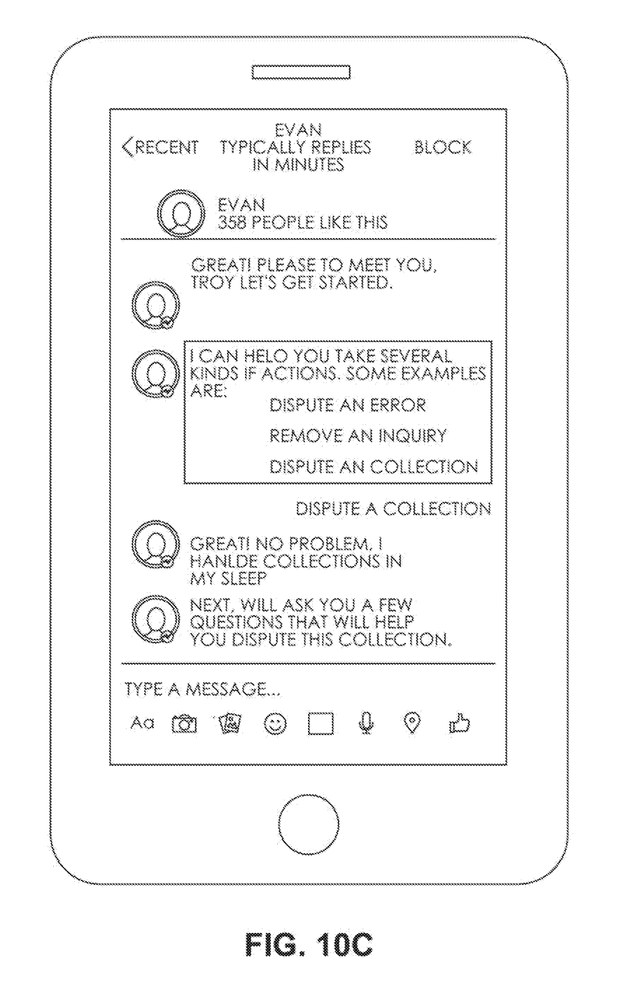

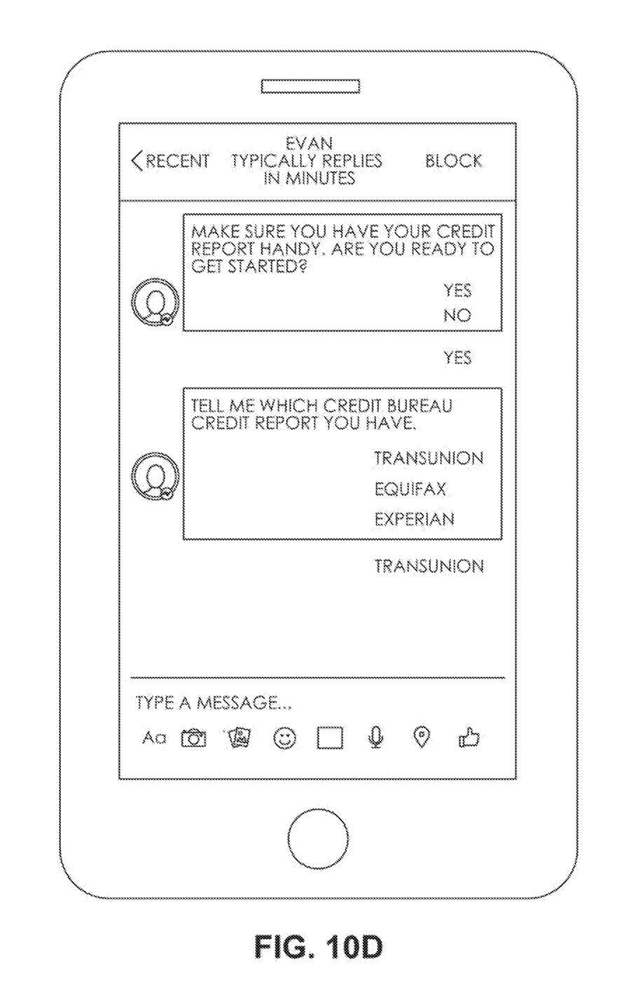

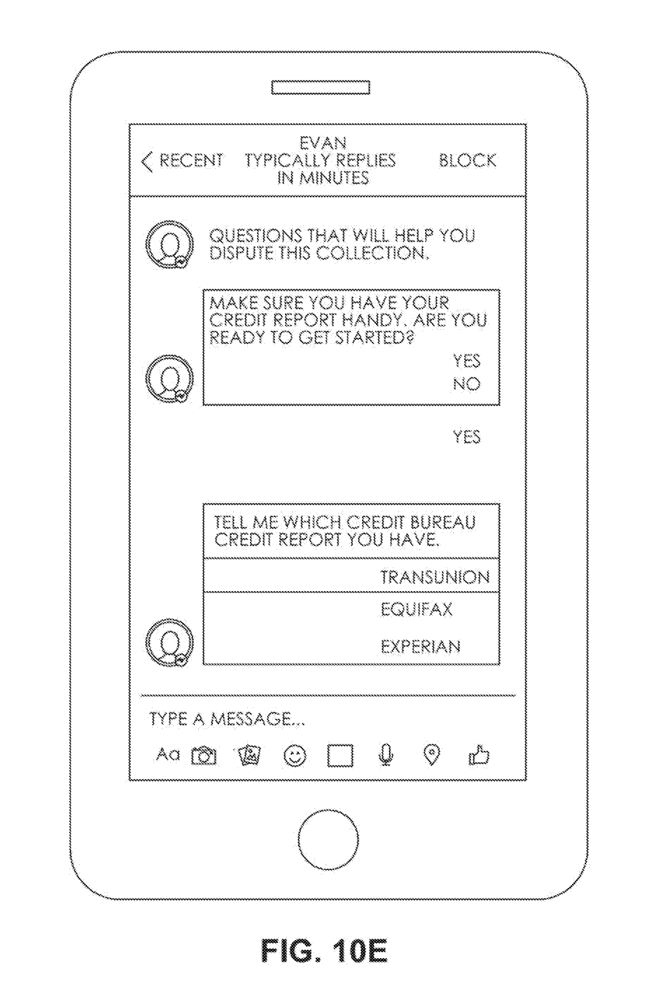

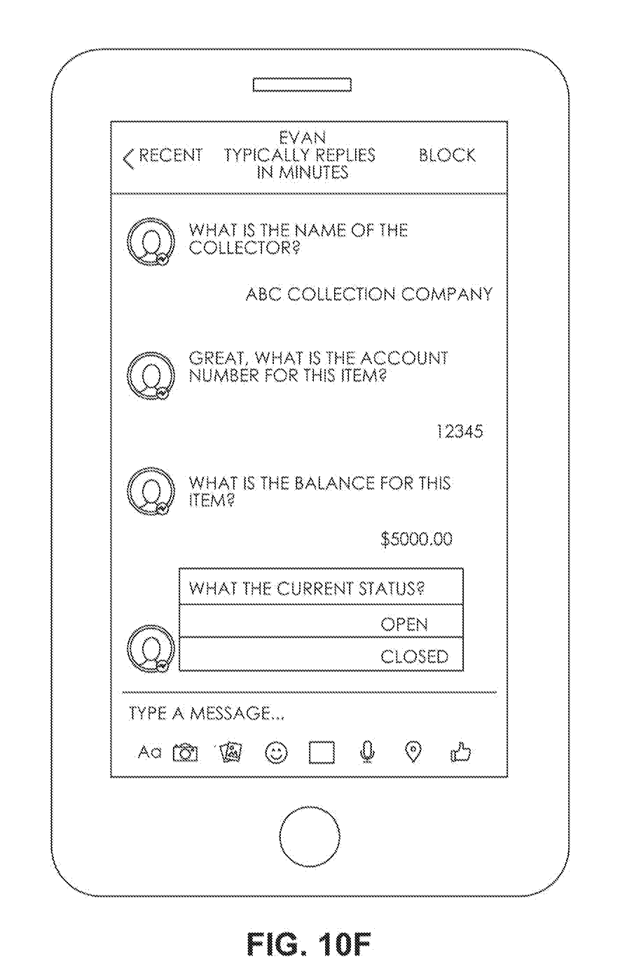

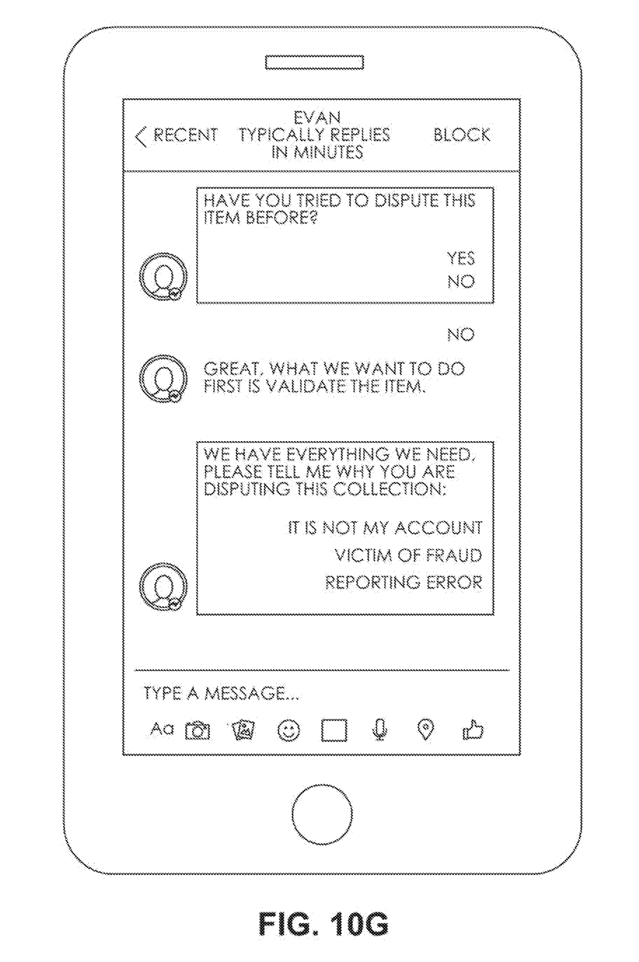

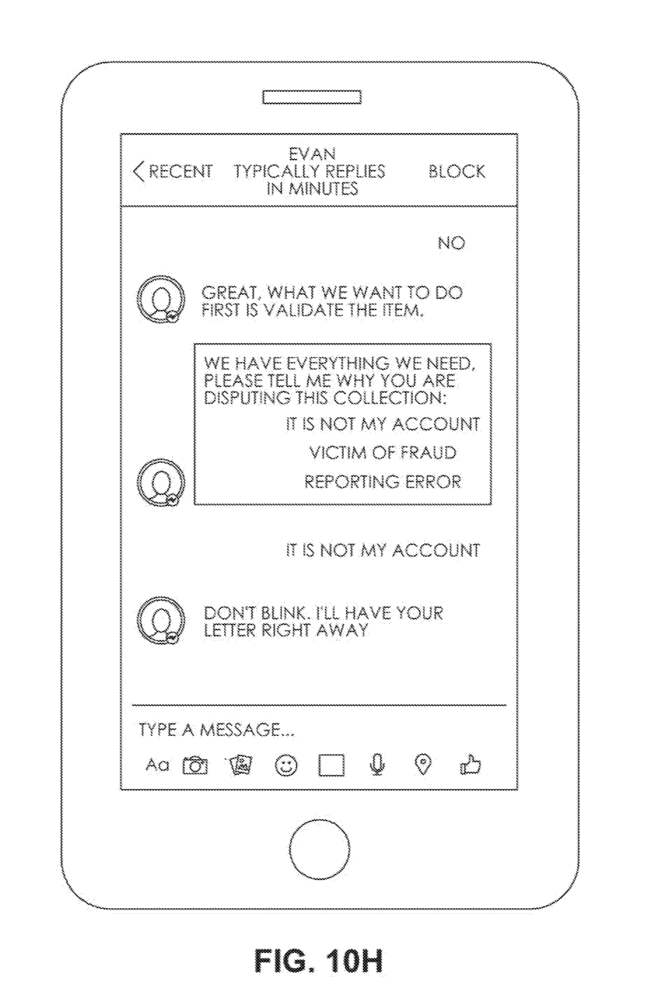

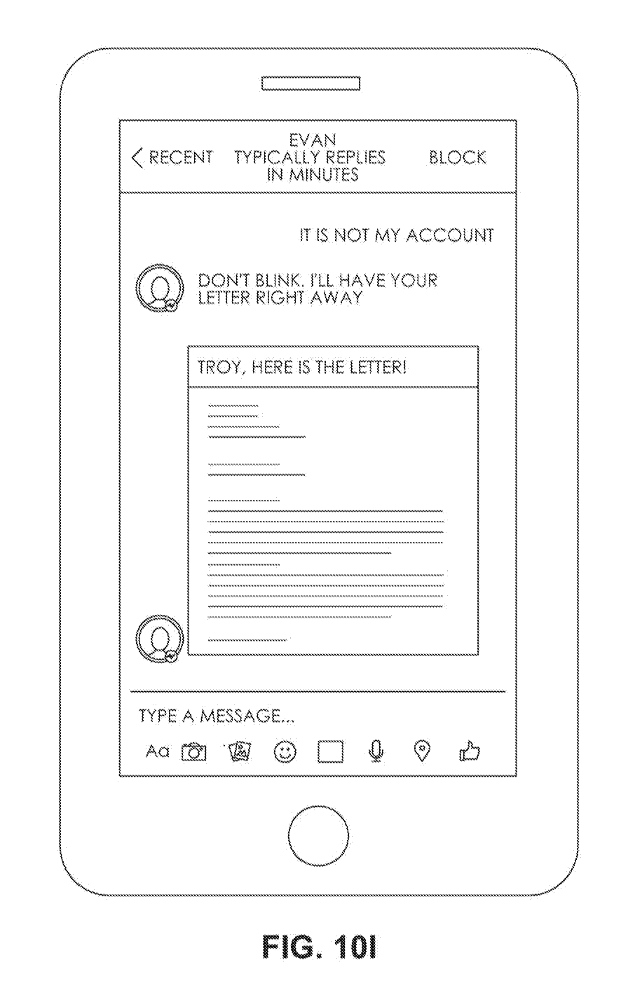

To aid understanding, this document is organized as follows. First, the automated creation of dispute communication customized based on a borrower's credit report and dispute history is briefly introduced with reference to FIGS. 1-3. Second, with reference to FIGS. 4-8, the discussion turns to exemplary data models that illustrate the operation of various embodiments. Specifically, an embodiment template synonym engine, and credit report data item model, are disclosed. Then, with reference to FIG. 9, an illustrative tabular view of an exemplary dispute resolution model is presented. Finally, with reference to FIG. 10, an exemplary mobile device application user interface illustrative of various embodiment credit dispute automation scenarios is presented.

FIG. 1 depicts an operational view of an embodiment credit report dispute resolution system choosing a credit report dispute communication recipe selected as a function of a borrower's credit report and credit report dispute history, generating a customized credit report dispute communication based on the selected dispute communication recipe adapted as a function of the borrower's credit report and credit report dispute history, and automatically improving the borrower's credit score based on transmitting the customized dispute communication to a credit stakeholder. In FIG. 1, the borrower 105 uses mobile device 110 to submit credit report request 112 via network cloud 115 to obtain credit report 120 from credit stakeholder 125. In the illustrated embodiment, credit report request 112 includes parameters configured to direct the credit stakeholder 125 to send the requested credit report 120 to credit report dispute resolution system 130. In the depicted embodiment, the credit stakeholder 125 may be a credit bureau. In the illustrated example, the credit stakeholder 125 may be a lender. Exemplary credit report dispute resolution system 130 includes processor 131 that is communicatively coupled with network interface 132 to receive input from a network and send output to a network. The processor 131 is in electrical communication with memory 133. The depicted memory 133 includes program memory 134. The depicted program memory 134 includes program instructions configured to implement Dispute Resolution Engine (DRE) 135. The depicted memory 133 also includes data memory 136. The depicted data memory 136 includes data configured to define Dispute Resolution Model (DRM) 140 and Dispute Resolution Rules (DRR) 145. The processor 131 executes the Dispute Resolution Engine (DRE) 135 using data in Dispute Resolution Model (DRM) 140 to generate customized dispute resolution communication 147. The dispute resolution system 130 sends the customized dispute resolution communication 147 to the mobile device 110. The mobile device 110 sends the customized dispute resolution communication 147 to the credit stakeholder 125. The credit stakeholder 125 may resolve the credit dispute based on the dispute resolution communication 147. In some embodiments, the credit stakeholder may send to the credit report dispute resolution system 130 an electronic message including the status of the credit dispute. In various implementations, the credit report dispute resolution system 130 may update the credit dispute history stored in the Dispute Resolution Rules (DRR) 145. The customized dispute resolution communication 147 is generated by processor 131 executing Dispute Resolution Engine (DRE) 135. In the depicted embodiment, the Dispute Resolution Engine (DRE) 135 selects a credit dispute communication recipe filtered from the set of credit dispute communication recipes 165 based on the borrower 105 response to questions determined as a function of the credit report 120. In the illustrated example, the dispute resolution recipes 165 include questions to ask the borrower, dispute item characteristics representing data needed from the borrower, and dispute communication templates predetermined based on various dispute types. In the depicted embodiment, each question in dispute resolution recipes 165 is identified by a Unique ID 150. In the depicted embodiment, the dispute resolution recipes 165 also include dispute item characteristics. In the illustrated example, the dispute item characteristics included in dispute resolution recipes 165 may include information or documents required to resolve a dispute. For example, a dispute item characteristic may include any of: the status of a credit account, a transaction date, an account balance, the name of a creditor, an account number, an account statement, a loan number, a loan payoff confirmation notice, or creditor contact details. In the illustrated embodiment, a dispute item characteristic may include any credit-related information provided by the user in response to a recipe-driven request from the dispute resolution system 130. In some embodiments, the Dispute Resolution Engine (DRE) 135 filters the dispute resolution recipes 165 as a function of user responses, narrowing the available recipe choices as the user 105 provides more information requested by the dispute resolution system 130. For example, a user initially beginning a credit dispute resolution session with the dispute resolution system 130 may be assigned a generic dispute resolution recipe specifying various types of user data required by multiple recipes. In some embodiments, as the dispute resolution system 130 continues to interact with the user 105 the Dispute Resolution Engine (DRE) 135 tabulates the user responses and filters the available recipe options base on the Dispute Resolution Rules (DRR) 145. In various designs, the Dispute Resolution Rules (DRR) 145 may define the subset of recipes appropriate for each type of dispute. In various embodiments, the Dispute Resolution Engine (DRE) 135 may select the next question to ask the user based on previous user responses tabulated by the Dispute Resolution Engine (DRE) 135. In the depicted embodiment, the Dispute Resolution Engine (DRE) 135 may determine the next question based on retaining the Unique ID 150 corresponding with the user response to each question asked. In the illustrated example, the Dispute Resolution Engine (DRE) 135 chooses from the dispute resolution recipes 165 to select an individual dispute resolution recipe based on the credit dispute round 155 and at least one of dispute resolution types 160. In the illustrated embodiment, the credit dispute round 155 corresponds to the iteration count of a credit dispute. In an illustrative example, a successful credit dispute resolution may require more than one dispute communication. For example, a lender may initially refuse to correct disputed negative information in a credit report, and instead request additional information. In an illustrative example, many iterations, or rounds, may be required to resolve a dispute, and various embodiments customize the generated dispute communication as a function of the credit dispute round 155. In some examples, a different dispute resolution recipe may be selected for an initial round than for a later round. In various embodiments, the selected recipe used in an early round may specify different language than the recipe selected for a later round. In some designs, the selected recipe used in an early round may specify different synonym replacements than the recipe selected for a later round. In the depicted embodiment, the dispute resolution types 160 may include types of credit disputes such as late payment, non-payment, balance owed, open account, credit denied, collection, foreclosure, lien, high balance, low balance, bankruptcy, or medical bill. In some embodiments, the dispute resolution types 160 may include any other type or category of credit dispute. In an illustrative example, any of the dispute resolution types 160 may correspond with one or more of the dispute resolution recipes. In some embodiments, the credit report 120 may include the credit report dispute history of the borrower 105. In the illustrated example, the dispute resolution system 130 automatically improves the user's credit score based on providing the credit stakeholder 125 access to the customized dispute communication 147 generated by the dispute resolution system 130 based on user-provided dispute item characteristics inserted within a dispute communication template chosen as a function of the selected recipe. In some embodiments, the dispute resolution system 130 may include an Artificial Intelligence Engine (AIE) implemented as program instructions accessible in the depicted program memory 134. In various embodiments, predictive analytic, machine learning, or artificial intelligence models used by the Artificial Intelligence Engine (AIE) may be represented as data accessible in the depicted data memory 136. In an illustrative example, the Artificial Intelligence Engine (AIE) may be implemented as a neural network. In some designs, the Artificial Intelligence Engine (AIE) may be implemented as a perceptron. In various implementations, the Artificial Intelligence Engine (AIE) may be implemented as a decision tree. In some embodiments, the Artificial Intelligence Engine (AIE) may be implemented as a support vector machine. In some implementations, the Artificial Intelligence Engine (AIE) may be implemented as a Gaussian mixture model. In various implementations, the Artificial Intelligence Engine (AIE) may be implemented as a Bayes classifier. In various embodiments, the Dispute Resolution Engine (DRE) 135 may train predictive analytic, machine learning, or artificial intelligence models used by the Artificial Intelligence Engine (AIE) as a function of credit report data. In various examples, the Artificial Intelligence Engine (AIE) models may be continuously trained in streaming fashion as a function of credit report data as new credit report data is processed. In some designs, the Artificial Intelligence Engine (AIE) may continuously test and evaluate the Artificial Intelligence Engine (AIE) models as the models are trained on new credit report data. In various examples, the Artificial Intelligence Engine (AIE) may evaluate the performance of new models using baseline or regression data representative of the performance of prior models. In some embodiments, the Artificial Intelligence Engine (AIE) may evaluate the performance of new models based on a regression test composed by a human credit dispute resolution expert. In various designs, the Artificial Intelligence Engine (AIE) may retain and use only models that are improved. In some embodiments, an Artificial Intelligence Engine (AIE) model may be designated as improved if the model's performance in providing automated credit report dispute resolution decisions exceeds a threshold predetermined as a function of the measured performance of prior Artificial Intelligence Engine (AIE) models used by the dispute resolution system 130. In some embodiments, the Dispute Resolution Engine (DRE) 135 may collaborate with the Artificial Intelligence Engine (AIE) to interactively correspond via electronic communication with the user 105. In an illustrative example, the Dispute Resolution Engine (DRE) 135 may employ the Artificial Intelligence Engine (AIE) to generate customized questions, responses, and credit dispute solutions based on the Artificial Intelligence Engine (AIE) models trained on credit report data. In some embodiments, the Dispute Resolution Engine (DRE) 135 may interactively correspond with the user 105 via a mobile app accessed via mobile device 110. In various designs, the mobile app may provide access to an online chat bot accessible via dispute resolution system 130. In some implementations, the mobile app may be a mobile chat bot. In an illustrative example, the Dispute Resolution Engine (DRE) 135 and Artificial Intelligence Engine (AIE) may answer credit related questions. In some embodiments, the Dispute Resolution Engine (DRE) 135 and Artificial Intelligence Engine (AIE) may assist with the process of using the system. In some designs, the Dispute Resolution Engine (DRE) 135 and Artificial Intelligence Engine (AIE) may collect additional data. In various implementations, the Dispute Resolution Engine (DRE) 135 and Artificial Intelligence Engine (AIE) may make credit related suggestions to help improve a credit score. In some implementations, the Dispute Resolution Engine (DRE) 135 and Artificial Intelligence Engine (AIE) may send communication directly to a creditor or bureau on a user's behalf. In some embodiments, the Dispute Resolution Engine (DRE) 135 and Artificial Intelligence Engine (AIE) may allow for an interactive experience adapted as a function of the continuous training of the Artificial Intelligence Engine (AIE) models. In an illustrative example, the Dispute Resolution Engine (DRE) 135 and Artificial Intelligence Engine (AIE) may continuously become more intelligent as the Artificial Intelligence Engine (AIE) models are trained on new credit report data. In some examples, the Dispute Resolution Engine (DRE) 135 and Artificial Intelligence Engine (AIE) may implement new functions, operations, or services determined based on learning the most effective approach to solving a credit dispute. For example, the Artificial Intelligence Engine (AIE) may learn that particular language in certain types of communication is more effective, based on training the Artificial Intelligence Engine (AIE) models as a function of credit report data and dispute outcomes. In an illustrative example, the Dispute Resolution Engine (DRE) 135 may use the most effective communication learned by the Artificial Intelligence Engine (AIE) and may in turn be able to implement more functions. In various designs, the interactive process flow of the Dispute Resolution Engine (DRE) 135 may be adapted based on new techniques and effective communication learned by the Artificial Intelligence Engine (AIE). For example, in some embodiments, the flow of the Dispute Resolution Engine (DRE) 135 may change depending on the request of the user 105 while communicating with the Artificial Intelligence Engine (AIE). In various designs, the Dispute Resolution Engine (DRE) 135 may update the Dispute Resolution Model (DRM) 140 or Dispute Resolution Rules (DRR) 145 using new techniques, flows, or outcomes learned by the Artificial Intelligence Engine (AIE).

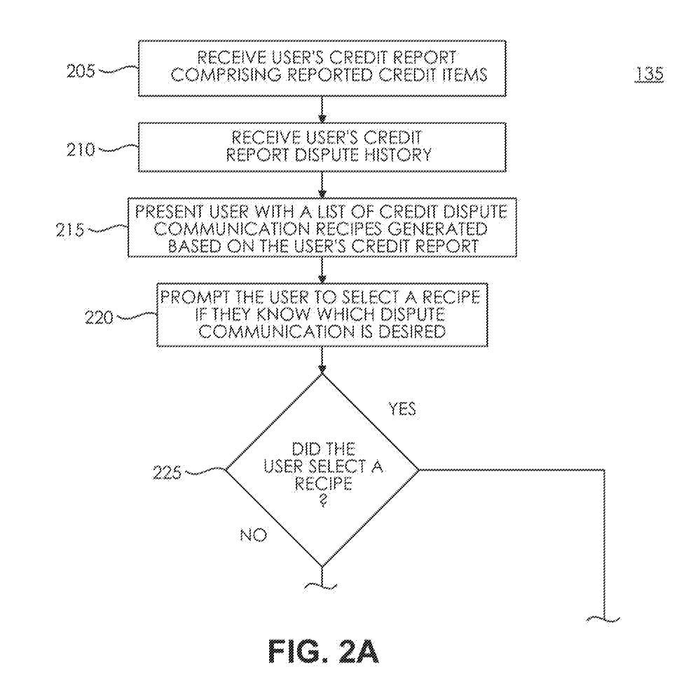

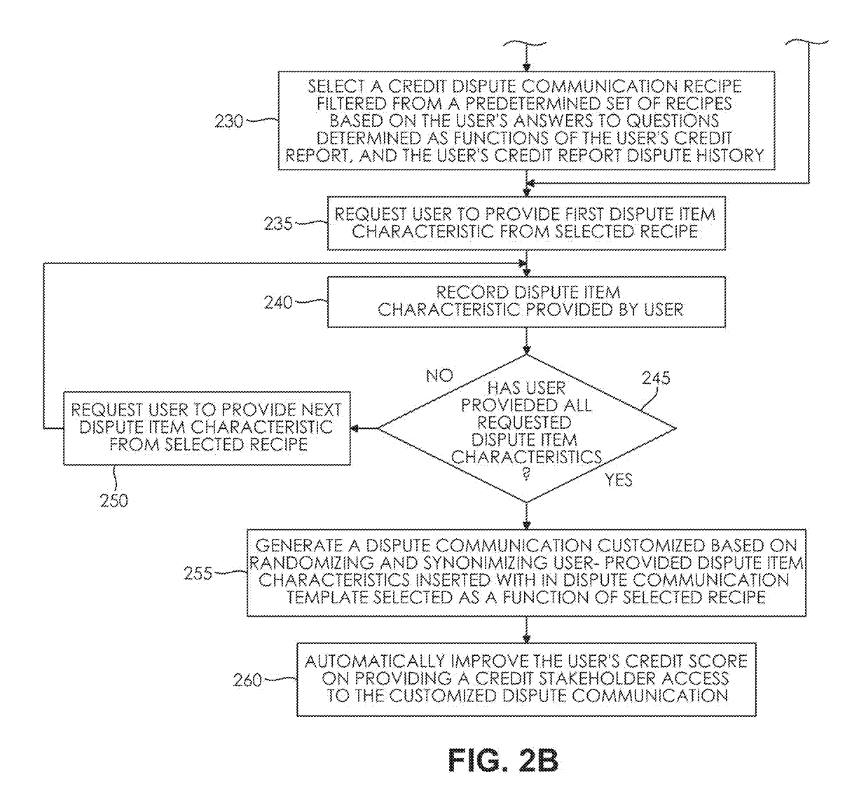

FIG. 2 depicts an exemplary process flow of an embodiment Dispute Resolution Engine (DRE). The method depicted in FIG. 2 is given from the perspective of the Dispute Resolution Engine (DRE) 135 executing as program instructions on processor 131, depicted in FIG. 1. In some embodiments, the Dispute Resolution Engine (DRE) 135 may execute as a cloud service communicatively coupled with system services, hardware resources, or software elements local to and/or external to dispute resolution system 130. In various embodiments, the Dispute Resolution Engine (DRE) 135 may execute as program instructions on the mobile device 110, depicted in FIG. 1. The depicted method begins at step 205 with the processor 131 receiving the borrower 105 credit report 120 comprising reported credit items. The method continues at step 210 with the processor 131 receiving the borrower 105 credit report dispute history. The method continues at step 215 with the processor 131 presenting the borrower 105 with a list of credit dispute communication recipes generated based on the user's credit report 120. The method continues at step 220 with the processor 131 prompting the borrower 105 to select a recipe if they know which dispute communication is desired. The method continues at step 225 with the processor 131 performing a test to determine if the borrower 105 selected a recipe. Upon a determination by the processor 131 at step 225 that the borrower 105 did not select a recipe, the method continues at step 230 with the processor 131 selecting a credit dispute communication recipe filtered from a predetermined set of recipes 165 based on the borrower answers to questions determined as functions of the borrower 105 credit report 120, and the user's credit report dispute history. Upon a determination by the processor 131 at step 225 that the borrower 105 did select a recipe, the method continues at step 235 with the processor 131 requesting the borrower 105 to provide the first dispute item characteristic from the selected recipe. The method continues at step 240 with the processor 131 recording the dispute item characteristic provided by the user. The method continues at step 245 with the processor 131 performing a test to determine if the borrower 105 has provided all requested dispute item characteristics. Upon a determination by the processor at step 245 that the borrower 105 has not provided all requested dispute item characteristics, the method continues at step 250 with the processor 131 requesting the borrower to provide the next dispute item characteristic from the selected recipe, and the method continues at step 240. Upon a determination by the processor at step 245 that the borrower 105 has provided all requested dispute item characteristics, the method continues at step 255 with the processor 131 generating a dispute communication 147 customized based on randomizing and synonymizing user-provided dispute item characteristics inserted within a dispute communication template selected as a function of the selected recipe. The method continues at step 260 with the processor 131 automatically improving the borrower 105 credit score based on providing credit stakeholder 125 access to the customized dispute communication 147.

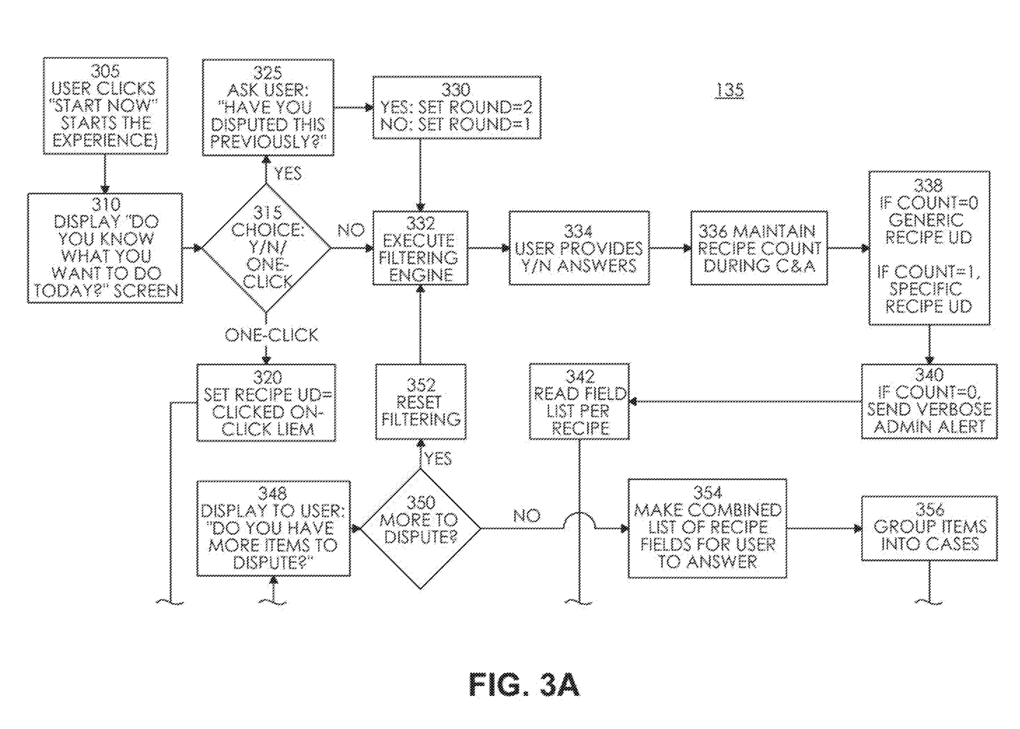

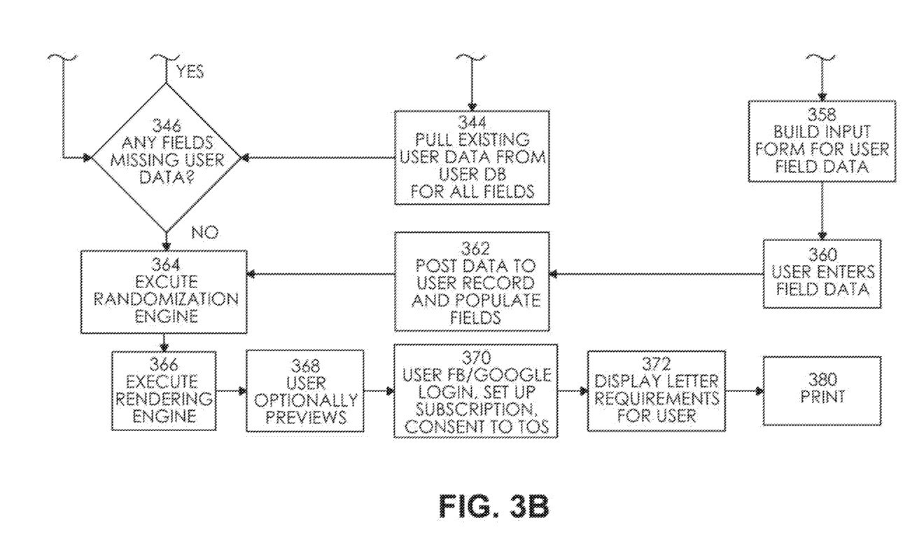

FIG. 3 depicts an exemplary process flow of an alternate embodiment Dispute Resolution Engine (DRE). The method depicted in FIG. 3 is given from the perspective of the Dispute Resolution Engine (DRE) 135 executing as program instructions on processor 131, depicted in FIG. 1. In some embodiments, the Dispute Resolution Engine (DRE) 135 may execute as a cloud service communicatively coupled with system services, hardware resources, or software elements local to and/or external to dispute resolution system 130. In various embodiments, the Dispute Resolution Engine (DRE) 135 may execute as program instructions on the mobile device 110, depicted in FIG. 1.

The depicted method begins at step 305 with the processor 131 displaying a “Start Now” button, which is used to begin the user wizard. The method continues at step 310 with the processor 131 displaying a nested tree listing of the “one-click” items, along with several examples of assisted (wizard-driven) tasks that are available to the user. In the depicted embodiment, the processor 131 then asks, “Do you know what you want to do today?” or something similar. In some embodiments, upon a subsequent use, the processor may ask “Tell me what your next dispute item is.”. The method continues at step 315 with the processor 131 receiving input representing the user's choice, either Y (does know what they want to do), N (does not know what they want to do), or the user may choose a one-click item. At step 315 a test is performed by the processor 131 to determine if the user chose N (No), Y (Yes), or One-click.

Upon a determination by the processor 131 at step 315 that the user chose One-click, the method continues at step 320 with the processor 131 making a reference that establishes that the active recipe for this task is the one the user clicked, based on setting the Recipe UID equal to the Clicked One-Click Item. The method continues at step 345 with the processor 131 performing a test to determine if any required fields are missing user data.

Upon a determination by the processor 131 at step 345 that required fields are missing user data, the method continues at step 348 with the processor 131 prompting the user to indicate if there are more items to dispute, and the method continues at step 350. At step 350 a test is performed by the processor 131 to determine if the user indicated there are more items to dispute. Upon a determination by the processor 131 at step 350 that the user has more items to dispute, the method continues at step 352 with the processor 131 resetting the filtering engine. In some embodiments, the processor 131 may reset the filtering Yes/No responses and proceed to a Display User Dispute Choices Screen, and the method continues at step 332 with the processor 131 executing the filtering engine. Upon a determination by the processor 131 at step 350 that the user does not have more items to dispute, the method continues at step 354 with the processor 131 making a combined list of recipe fields for the user to answer. In some embodiments, the processor 131 may combine all of the stored field requirements for all user-downselected letters, and remove duplicates. The method continues at step 356 with the processor 131 grouping items into cases. In some embodiments, the processor 131 may group items into cases, where a case may be 1 to 5 items of the same type. In various designs, as many as five items may be combined into one letter. In some examples, overflow accounts (items) over 5, may go into a duplicate letter of the one that is “full”. In various implementations, the processor 131 may repeat grouping items into cases until no items remain. The method continues at step 358 with the processor 131 building an input form for user field data. In some embodiments, the processor 131 may use the deduped field list from step 354 to build a user input form that shows the field name using its simple English name, and a space beside or below it for the user to input the data for that field. In various designs, the processor 131 may create a dispute instructions table and populate it with the account number when combining items into a letter. The method continues at step 360 with the processor 131 receiving user field input data displayed for user choice, one dispute instruction from the dispute instructions table, per account. In various implementations, a dispute instruction must be chosen for each account, and all accounts must have a dispute instruction, even if they are identical. The method continues at step 362 with the processor 131 posting data to the user and recording and populating data fields. In some implementations, the processor 131 may store the dispute instruction data in the table with that account number, and repeat until all accounts in the case have instructions. The method continues at step 364 with the processor 131 executing the randomization engine.

Upon executing the Filtering engine at step 332, the method continues at step 334 with the processor 131 interacting with the user to selectively narrow the dispute communication recipe population to an effective recipe suited to generate a solution for the user's dispute communication needs. The processor 131 interacts with the user to obtain the user's Yes/No answers. In some embodiments, the processor 131 engages the user in iterative interactive with the filtering engine. In some embodiments, the processor 131 may determine which question to display based on recalculating the counts of all “x” or 1 or “on” characteristics of the questions, as disclosed by the dispute resolution model illustrated in FIG. 9, choosing the question with the most of those “x” values. In various embodiments, the processor 131 may repeat the math operation to do a Boolean AND of all previously confirmed “Yes” criteria to narrow the population, when the user answers Yes to a question. In some implementations, the processor may recalculate the frequencies again, and ask the question with the highest count. The method continues at step 336 with the processor 131 maintaining the recipe count during the interactive question and answer recipe filtering stage, based on retaining the Yes/No answers and question Unique IDs 150. The method continues at step 338 with the processor 131 repeating steps 334 and 336 until the recipe count equals one. In some embodiments, if the recipe count is zero, the processor 131 sets the Recipe Unique ID to a predetermined Generic Recipe UID. In various embodiments, if the recipe count is one, the processor 131 sets the Recipe Unique ID to a Specific Recipe UID for a recipe selected as a function of user responses to questions. In various designs, if the recipe count equals one, the processor 131 may stop the filtering engine and store the recipe UID for further user input in later steps, skipping step 342. In some implementations, if the recipe count equals zero, the processor 131 may select a type-specific default letter and stop the filtering engine, and issue an admin alert per step 340. The method continues at step 340 with the processor 131 sending an administrative alert if the recipe count is zero. In some embodiments, if the recipe count equals zero, the processor 131 may issue an administrative alert. In various designs, the administrative alert may contain the series of Y/N responses and question UIDs that led to the null result. The method continues at step 342 with the processor 131 reading the field list per recipe. In some embodiments, the processor 131 may read the list of required fields for each recipe and store into temporary storage for form-based Q&A in step 360. In various implementations, if a required field is a Dispute Instruction field, the processor 131 may ask the dispute instruction immediately of the user, then store it for insertion into the letter. The method continues at step 344 with the processor 131 pulling existing user data from the user DB for all fields. In some embodiments, the processor 131 may read the user record to obtain all available data to populate recipe fields, and store the UIDs of fields that do not yet have data. The method continues at step 345 with the processor 131 performing a test to determine if required fields are missing user data.

Upon a determination by the processor 131 at step 345 that no required fields are missing user data, the method continues at step 364 with the processor 131 executing the randomization engine. In some embodiments, the processor 131 may start the randomization engine based on generating a random seed, k, with a value from 1 to N where N is the number of variants for a letter element, in the recipes table. In some designs, the processor 131 may use the generated random seed k to look up the kth variant for that element and return that kth variant for use in the customized dispute communication letter. In various embodiments, the processor 131 may repeat the randomization process for all letter elements.

Upon executing the Randomization engine at step 364, the method continues at step 366 with the processor 131 executing the rendering engine. In some embodiments, the processor 131 may render the letter elements into the letter template, including all user-input field data, dispute instruction table contents, and current date. The method continues at step 368 with the processor 131 prompting the user to optionally preview the rendered dispute communication. In some embodiments, the processor 131 may present the user with a Preview button, which the user may click to see a preview of the letter. In various designs, the processor 131 may overlay a watermark on top of the preview and display it smaller than what would be required to print it legibly, for visitors who are not yet registered (that is, they are not yet registered users). In an illustrative example, the processor 131 may not display a watermark for logged-in users, and may permit a high-quality zoomed-in view for logged-in users. The method continues at step 370 with the processor 131 prompting users who are not logged in or registered, to log in, or register and pay, and consent to the Terms of Service, before obtaining their customized dispute communication. In various designs, the processor 131 may interactively guide the user through completing steps including registration and payment before providing the user with access to the customized dispute communication. The method continues at step 372 with the processor providing the user a bulleted list for reference including short textual explanations that with each correspondence, the user must send a photocopy of several identifying documents. In some embodiments, the processor 131 may present the user with example images so the user can see exactly what they are to obtain from their own records, photocopy, and include with the letter. In various examples, documents required may include: Copy of Driver's License or state-issued ID; Copy of recent utility bill; Copy of the user's Social Security card; and, any other supporting documentation the letter requires. Then, the method continues at step 380 with the processor 131 printing or displaying the customized dispute communication 147, and the method ends.

Upon a determination by the processor 131 at step 315 that the user chose Y (does know what they want to do), the method continues at step 325 with the processor 131 asking the user: “Have you disputed this item previously?” and the method continues at step 330 with the processor 131 setting the Round value to 2 if the user has previously disputed this item, or setting the Round value to 1 if the user has not previously disputed this item. In some scenarios, this is critical for establishing which round the user is in. In various implementations, the system will also know if the user has previously disputed an item, because they have, or don't have, a login and history on this item. The method continues at step 332 with the processor 131 starting the filtering engine, using the round value from step 330 or step 315, and all other applicable user and system information to pre-narrow the population of recipes.

Upon a determination by the processor 131 at step 315 that the user chose N (does not know what they want to do), processor 131 sets the Round value to 1, and the method continues at step 332 with the processor 131 starting the filtering engine, using the round value from step 315, and all other applicable user and system information to pre-narrow the population of recipes.

FIG. 4 depicts an exemplary tabular view of an embodiment synonym engine.

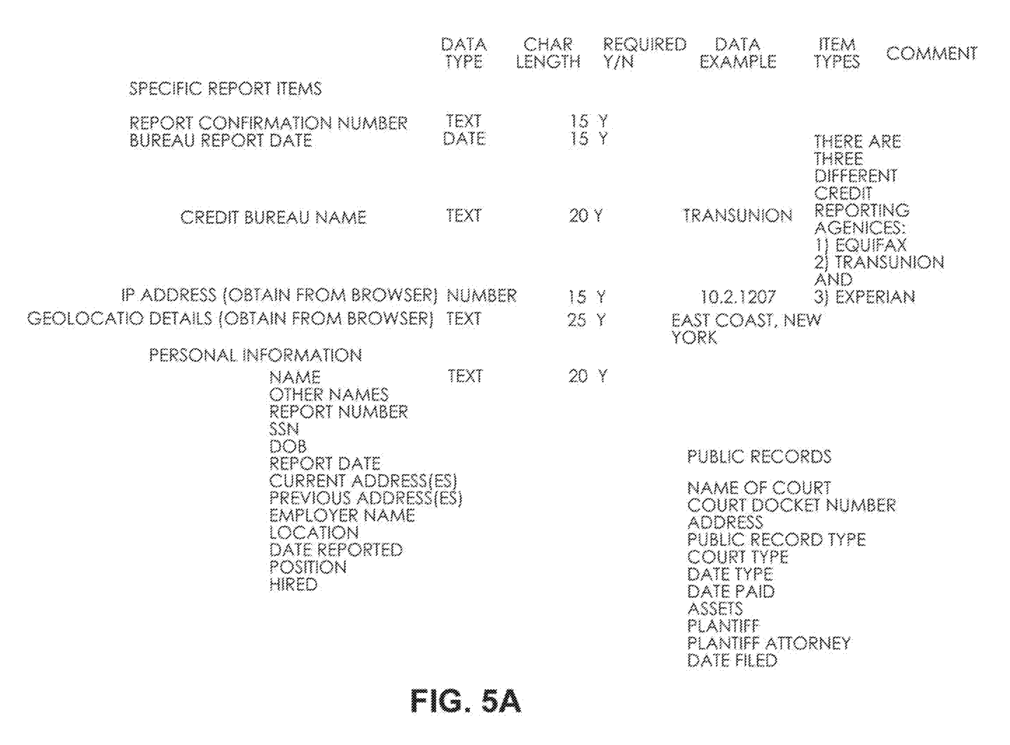

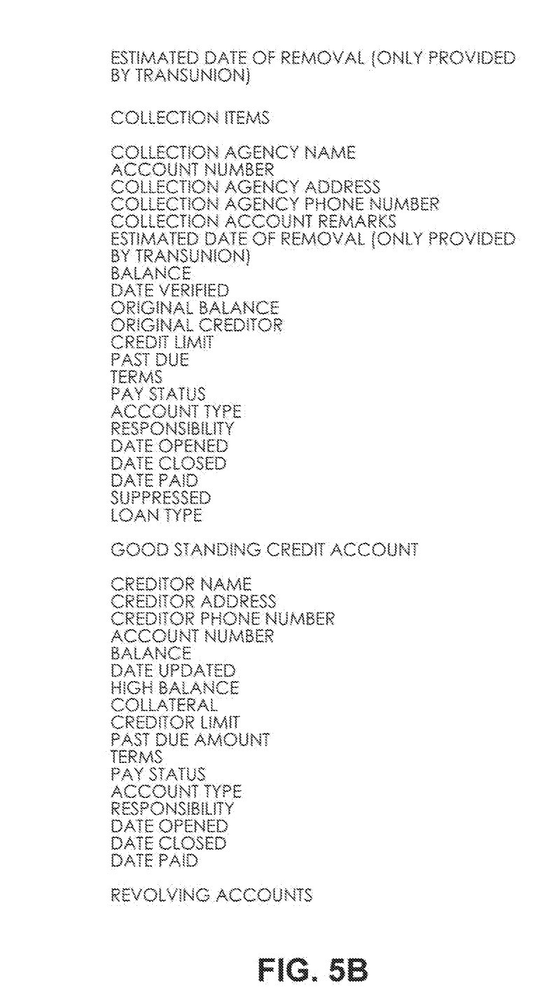

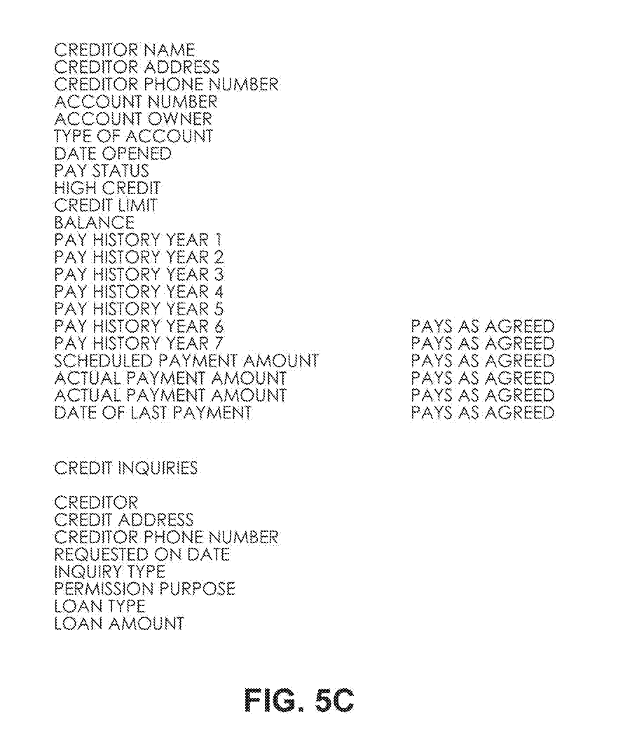

FIG. 5A through FIG. 5C depicts an exemplary tabular view of an embodiment credit report data item model.

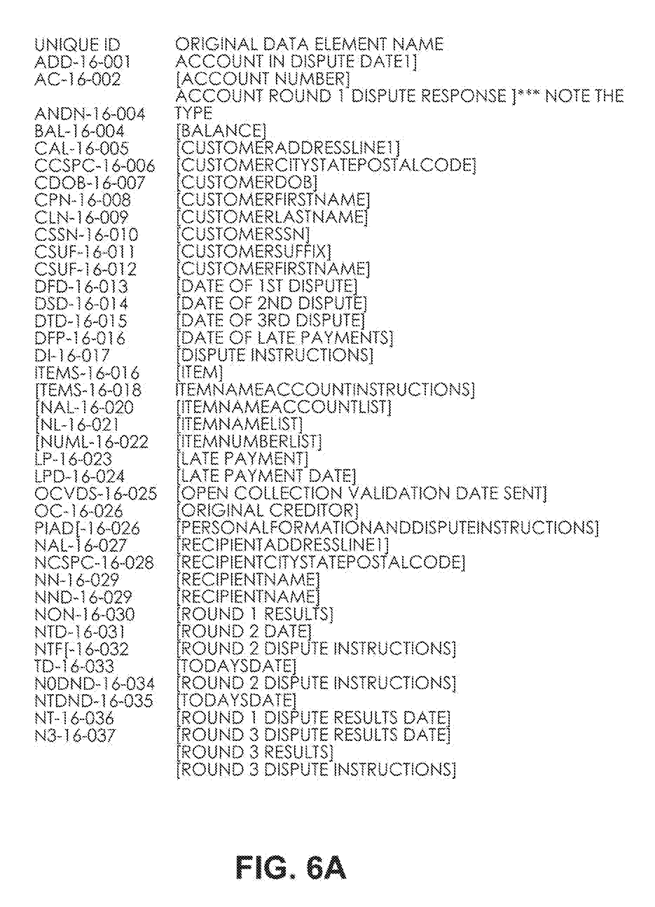

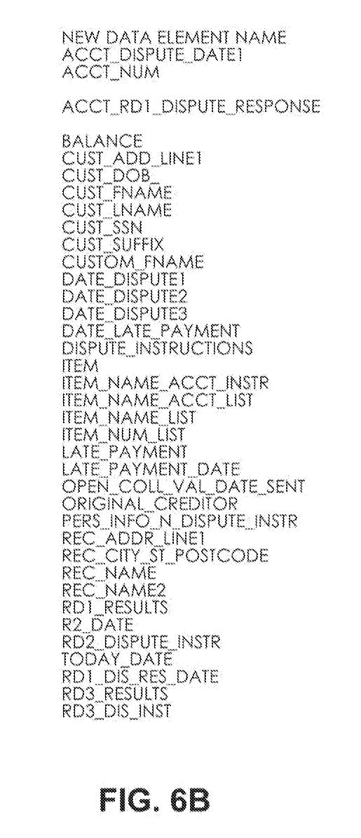

FIG. 6A and FIG. 6B depicts an exemplary tabular view of an embodiment data element model.

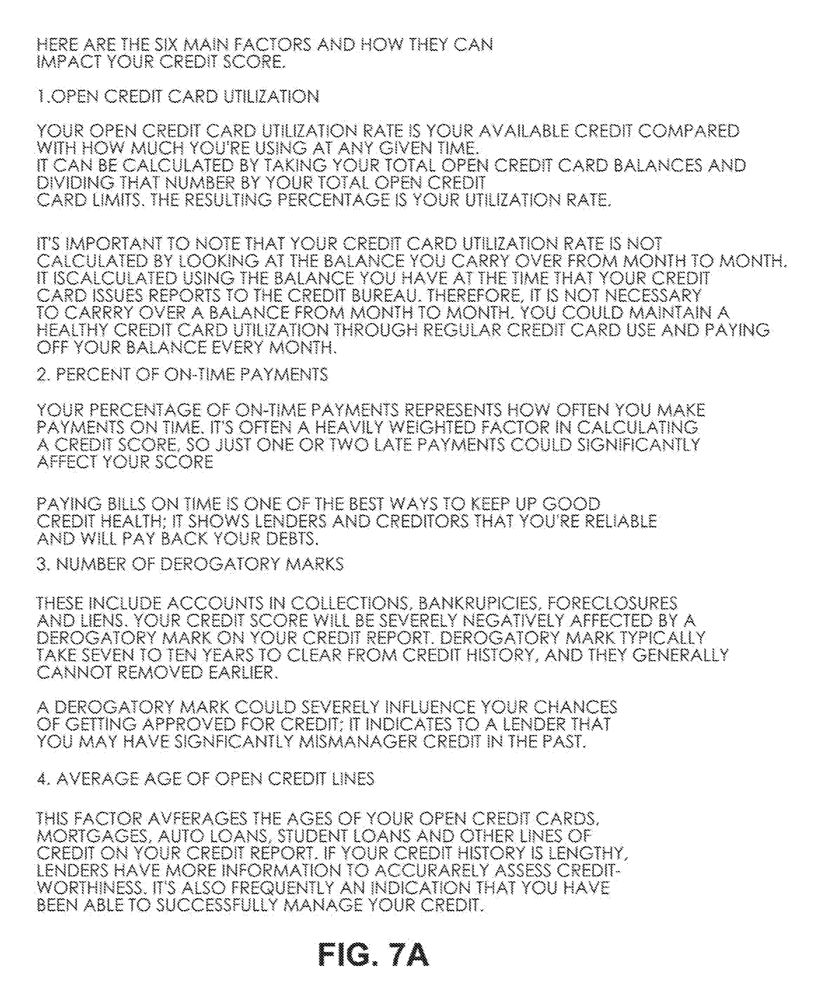

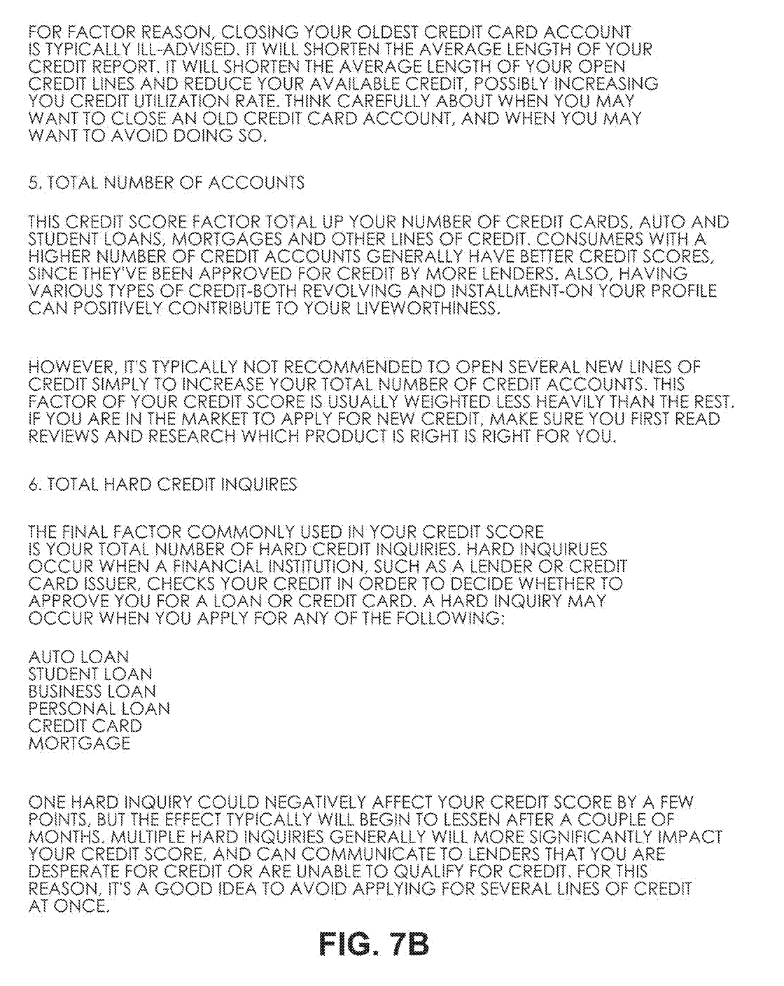

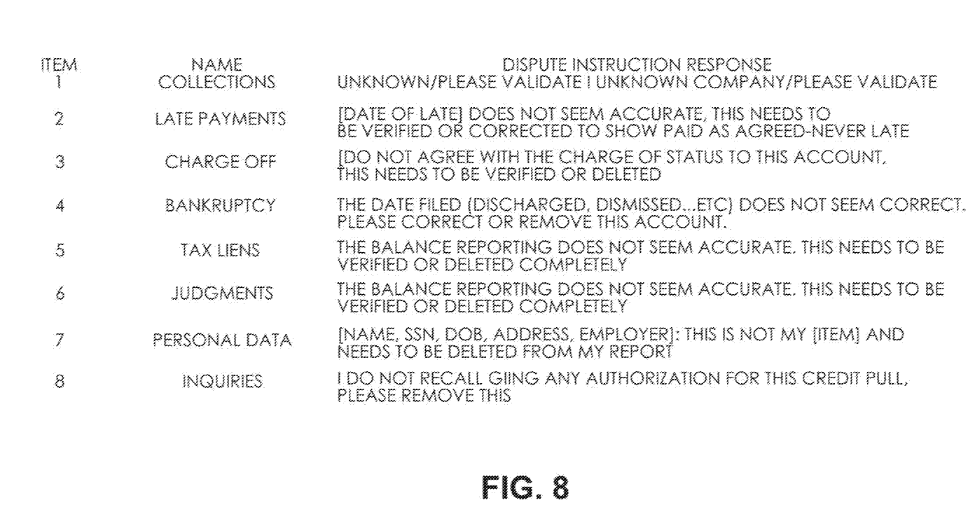

FIG. 7A and FIG. 7B depicts exemplary credit impact summaries.

FIG. 8 depicts exemplary dispute instructions.

FIG. 9A through FIG. 9RR depicts an exemplary tabular view of an embodiment dispute resolution model.

FIG. 10A through FIG. 10I depict exemplary screen shots of an illustrative mobile device user interface view of an embodiment mobile application. In FIG. 10, the depicted exemplary application user interface is illustrative of various embodiment credit dispute automation scenarios that may be interactively engaged by the user 105 via mobile device 110, depicted in FIG. 1. In various designs, the interactive process flow of the Dispute Resolution Engine (DRE) 135 illustrated in FIG. 10 may be adapted based on new techniques and effective communication learned by the Artificial Intelligence Engine (AIE). For example, in some embodiments, the flow of the Dispute Resolution Engine (DRE) 135 may change depending on the request of the user 105 while communicating with the Artificial Intelligence Engine (AIE).

Although various embodiments have been described with reference to the Figures, other embodiments are possible. For example, some embodiments of the present invention may quickly and easily resolve credit disputes between borrowers and credit stakeholders. Various designs may provide a self-service platform for consumers to easily resolve disputed information in a prospective borrower's credit report. In various scenarios exemplary of some embodiment's usage, a user may be a credit consumer. In some examples, a credit consumer may be a borrower. In some illustrative examples, the credit consumer may be a prospective borrower seeking to secure a loan. In some scenarios exemplary of various implementation's usage, a credit stakeholder may be a lender. In some illustrative examples, the credit stakeholder may be a credit report agency. Some embodiments may automatically improve consumer's credit scores based on automating the resolution of credit report information that may be in dispute between a credit consumer and a credit stakeholder. Various embodiments may provide an automated solution to improving credit scores.

Some studies report that as many as forty million Americans, or almost twenty percent of the US population, may have a credit score below six hundred, making them high risk borrowers. In some scenarios, high risk borrowers may be denied credit. In various examples, high-risk borrowers may be limited by their high-risk borrower status to credit options that are less desirable to the credit consumer. For example, a high-risk borrower may be offered loans with a higher interest rate than a lower-risk borrower. Various estimates place the market size of the US credit repair industry near six billion dollars.

In various scenarios illustrative of credit consumer experience with prior art credit repair, some credit consumers may be frustrated by expensive options to repair their credit, with only limited effectiveness. In an illustrative example of the prior art credit repair industry, some credit consumers have employed law firms to prepare customized dispute resolution communications. In some examples of prior art credit repair, law firms—big and small—may charge up to fifteen hundred dollars per dispute resolution. In various examples illustrative of prior art credit repair, law firms and other credit repair providers may require high recurring charges. Some credit repair providers may use fixed dispute resolution templates based on the type of dispute. Such prior art fixed dispute resolution templates may have a low likelihood of resolving a credit dispute in the credit consumer's favor. Some consumers have been frustrated by poor customer service and a lack of innovation from credit repair providers using prior art credit repair. In some scenarios exemplary of prior art credit repair, individual letters may be handwritten or typed, and then mailed or faxed to creditors. In various prior art credit repair scenarios, a person seeking to improve their credit score may have to type, write or compose individual letters one at a time.

In various scenarios exemplary of the use of some embodiments of the present invention, a credit repair consumer may be charged a flat rate for access to embodiment credit repair systems or methods for a period of time. In some embodiments, customized credit dispute resolution documents may be automatically created to resolve credit disputes while saving potentially hundreds or thousands of dollars in lawyer or credit repair provider fees.

Some embodiments may provide an automated process powered by a processor engine for initiating and resolving credit disputes with creditors and credit bureaus. In various designs, a synonym engine may produce customized documents for consumers to initiate credit disputes with creditors and credit reporting agencies. In some usage scenarios illustrative of various embodiments, a customization algorithm allows consumers to use a website to create customized documents they can email, mail or fax to creditors and credit reporting agencies. For example, in various implementations, a copy of the consumer's credit report may be uploaded into an embodiment web-based system. In some scenarios, the user engine of various embodiments may ingest and parse the consumer's credit report in a pre-processing step, for subsequent semantic or ontological analysis, to identify negative information, inaccuracies and various other elements that hurt consumers' credit. In some embodiments, a user may be guided through a series of questions, compiling a custom document for them to send to credit stakeholders including creditors or credit reporting agencies. Some embodiments may provide a self-service platform for consumers to increase their credit scores. In some usage scenarios illustrative of various embodiments, a credit consumer may be provided with access to an automated credit repair service via an embodiment web platform. In various embodiments, automated credit repair services may be provided by an embodiment phone app. Some embodiments may automate credit dispute resolution based on credit consumer responses to questions determined as a function of the credit consumer's credit report and credit report dispute history. In scenarios illustrative of usage of various embodiments, millions of people may be served with customized and effective credit repair based on embodiment processes. Some designs may produce custom unique documents quickly for each credit consumer experience. Various embodiments may include many different data elements to produce individualized, customized credit report dispute communications. For example, some embodiments may have over 100 million different data elements utilized to produce individualized custom documents. Various implementations may nearly instantaneously identify issues, and quickly produce documents based off the data our system collects from the credit consumer's uploaded credit report. Some embodiments may generate customized documents for consumers by using intelligent recognition software based on AI, machine learning, and predictive analytics. In some designs, AI may be trained to understand the credit reporting process, to predict an optimal credit dispute communication based on the state of the credit dispute. Various implementations may identify the action needed on an individual's credit report based on AI and machine learning. Some embodiments may determine the optimal credit report dispute communication customized as a function of requirements of lenders, creditors, banks, mortgage companies, car dealerships and any potential creditor based on the data elements captured by our automated credit dispute machine. In various designs, embodiment AI and predictive analytic subsystems may continuously learn as new data is ingested by the system, to have the highest level of understanding of a consumer's credit, the creditor's requirements, and the credit bureau's reporting systems.

In an illustrative example in accordance with an embodiment of the present invention, the system and method are accomplished through the use of one or more computing devices. As depicted in FIG. 1, one of ordinary skill in the art would appreciate that an exemplary computing device appropriate for use with embodiments of the present application may generally be comprised of one or more of a Central processing Unit (CPU) which may be referred to as a processor, Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to affect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While some of the foregoing drawings and description set forth functional aspects of some embodiments of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are exemplary, and provided for illustrative disclosure of enablement and exemplary best mode of various embodiments. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A method to improve a user's credit score, comprising:
selecting a credit dispute communication recipe filtered from a set of recipes based on the user's response to questions determined as a function of the user's credit report and the user's credit report dispute history; and,
automatically improving the user's credit score based on providing a credit stakeholder access to a customized dispute communication generated based on user-provided dispute item characteristics inserted within a dispute communication template chosen as a function of the selected recipe.

2. The method of claim 1, wherein the credit report further comprises reported credit items.

3. The method of claim 1, wherein the credit report dispute history further comprises a record of prior dispute communication including the credit dispute round.

4. The method of claim 1, wherein the credit dispute communication recipe further comprises credit dispute item characteristics.

5. The method of claim 1, wherein the selected credit dispute communication recipe is filtered from a set of recipes as a logical function of the user's response.

6. The method of claim 1, wherein the generated dispute communication is customized based on synonym replacements determined as a function of the user-provided dispute item characteristics.

7. The method of claim 1, wherein the generated dispute communication is customized based on randomly selected synonym replacements determined as a function of the user-provided dispute item characteristics.

8. The method of claim 1, wherein the credit report dispute history further comprises the dispute resolution status.

9. The method of claim 8, wherein selecting the credit dispute communication recipe further comprises filtering as a function of the dispute resolution status and the credit dispute round.

10. A method to improve a user's credit score, comprising:
receiving the user's credit report, comprising reported credit items;
receiving the user's credit report dispute history, comprising a record of prior dispute communication;
selecting a credit dispute communication recipe filtered from a set of recipes based on the user's response to questions determined as a function of: the reported credit items; the user's prior dispute communication; and, the credit dispute round determined as a function of the record of prior dispute communication and user response; and,
automatically improving the user's credit score based on providing a credit stakeholder access to a customized dispute communication generated based on user-provided dispute item characteristics inserted within a dispute communication template chosen as a function of the selected recipe.

11. The method of claim 10, wherein the credit dispute communication recipe further comprises credit dispute item characteristics.

12. The method of claim 10, wherein the selected credit dispute communication recipe is filtered from a set of recipes as a logical function of the user's response.

13. The method of claim 12, wherein the user's response further comprises credit dispute item characteristics.

14. The method of claim 10, wherein the generated dispute communication is customized based on synonym replacements determined as a function of the user-provided dispute item characteristics.

15. The method of claim 10, wherein the generated dispute communication is customized based on randomly selected synonym replacements determined as a function of the user-provided dispute item characteristics.

16. The method of claim 10, wherein the prior dispute communication further comprises an indication of the prior dispute communication outcome.

17. The method of claim 16, wherein the credit dispute communication recipe is selected based on an artificial intelligence trained to recognize an optimal recipe predicted as a function of the prior dispute communication outcome and the credit dispute round.

18. A method to improve a user's credit score, comprising:
receiving the user's credit report, comprising reported credit items;
receiving the user's credit report dispute history, comprising a record of prior dispute communication;
receiving an indication of the prior dispute communication outcome, including the dispute resolution status;
selecting a credit dispute communication recipe filtered from a set of recipes as a logical function of the user's response to questions determined as a function of:
the reported credit items; the user's prior dispute communication; and, the credit dispute round determined as a function of the record of prior dispute communication and user response; and,
automatically improving the user's credit score based on providing a credit stakeholder access to a customized dispute communication generated based on user-provided dispute item characteristics inserted within a dispute communication template selected as a function of the selected recipe.

19. The method of claim 18, wherein the credit dispute communication recipe is selected based on an artificial intelligence trained to recognize an optimal recipe predicted as a function of the dispute resolution status and the credit dispute round.

20. The method of claim 19, wherein the method further comprises training the artificial intelligence as a function of the prior dispute communication outcome.
